(19) United States
(12) Patent Application Publication
(10) Pub. No.: US 2026/0228088 A1
(43) Pub. Date: Aug. 6, 2026

(54) STORAGE DEVICE AND STORAGE CONTROL METHOD

(71) Applicant: Hitachi Vantara, Ltd., Kanagawa-ken (JP)

(72) Inventors: Kenta SATO, Tokyo (JP); Takaki MATSUSHITA, Tokyo (JP); Akira DEGUCHI, Tokyo (JP)

(73) Assignee: Hitachi Vantara, Ltd., Kanagawa-ken (JP)

(21) Appl. No.: 19/312,626

(22) Filed: Aug. 28, 2025

(30) Foreign Application Priority Data
Feb. 5, 2025 (JP) 2025-017939

(51) Int. Cl. G06F 11/14

(52) U.S. Cl. CPC G06F 11/1464; G06F 2201/84

(57) ABSTRACT

A storage apparatus includes: a first storage node having a primary volume from or to which data is read or written with a host; and a second storage node, in which each of the first storage node and the second storage node holds a same reference snapshot volume, and the first storage node and the second storage node manage a snapshot volume based on difference data between the reference snapshot volume and the snapshot volume.

### BACKGROUND OF THE INVENTION

### 1. Field of the Invention

The present invention relates to a storage apparatus and a storage control method, and is suitably applied to, for example, a storage system related to a technique for creating a snapshot volume using a snapshot function.

### 2. Description of Related Art

In recent years, a snapshot function is an important function in a storage apparatus. The snapshot function has a function of creating a copy of data stored in a storage apparatus at a certain moment (point-in-time). The copying performed by the snapshot function does not copy an entity of data, but copies mapping information between a logical storage area called a volume and a physical storage area such as a hard disk drive (HDD) or a solid state drive (SSD), and thus the snapshot function has a feature of performing copy in a short time. Further, data sharing and difference management using the mapping information, that is, management of a data sharing relation using the mapping information, are performed between a created snapshot volume and a primary volume which is a volume serving as a copy source. In a storage apparatus, only a storage capacity corresponding to the sum of a data capacity of one volume and a capacity of difference data between volumes can be consumed and stored. In addition, restore processing for restoring data of the primary volume using a snapshot volume can be executed in a short time by performing restoring only difference data between the primary volume and the snapshot volume.

In general, an information technology (IT) system uses a snapshot function having such features in various applications. The most typical application is to acquire a snapshot as a backup of a volume to be used for actual work. In recent years, it is required to acquire a backup at a high frequency as a countermeasure against Ransomware. The use of the snapshot function is suitable for such a requirement. Further, in addition to the use such as Test/Dev for constructing a development environment, a verification environment, and an evaluation environment by using the acquired snapshot volume, there is also an application such as repurposing for using the snapshot volume for a purpose different from actual work such as analysis work. As a completely different application, for example, in a virtual desktop infrastructure (VDI), there is an application that an operating system (OS) disk allocated to a large number of virtual machines (VM) is generated from a volume serving as a master using a snapshot function.

In recent years, there are more storage apparatuses that achieve high scalability by configuring a plurality of storage nodes in a cluster manner. In such a storage apparatus, IO processing for a volume, a storage capacity for storing data stored in a volume, and the like are often independent for each storage node. The snapshot function generally has a limitation that the primary volume and the snapshot volume have to be arranged in the same storage node.

Generally, in a storage apparatus, in order to prevent a storage capacity of each storage node from being consumed and a load associated with IO processing from being biased, rebalancing is performed, which is control for distributing a volume to each storage node and control for eliminating the storage capacity consumption and the load bias by migrating a volume among a plurality of storage nodes. However, when the snapshot function is used, these controls do not appropriately function due to the above-described limitation, and there is a problem that storage capacity consumption and load bias occur.

Specifically, there is a case where a large number of snapshot volumes are acquired for one volume. In such a case, due to the above-described limitation, the primary volume and the large number of snapshot volumes are arranged in the same storage node. As a result, IO processing for a large number of snapshot volumes needs to be performed by a single storage node, and the load of the single storage node becomes enormous. Even if the above-described rebalancing is performed, a set of the primary volume and the large number of snapshot volumes associated with the primary volume is collectively migrated, and a data amount to be migrated becomes very large. Therefore, there is a problem that there is no appropriate migration destination storage node or a load of a migration destination becomes excessive.

PTL 1 discloses a technique of arranging a snapshot volume across a plurality of storage nodes. In the technique disclosed in PTL 1, when a migration source storage node in which a primary volume is present falls into a high load state or the like, only the primary volume is copied to a migration destination storage node to create a migration destination primary volume in a state in which a snapshot volume acquired in the migration source storage node is stored in the migration source storage node. Furthermore, in the technique disclosed in PTL 1, when a migration destination storage node receives a snapshot volume acquisition request after the primary volume is copied, the migration destination storage node is controlled to separately create a snapshot volume for the migration destination primary volume.

### CITATION LIST

### Patent Literature

PTL 1: JP6772202B

### SUMMARY OF THE INVENTION

As described above, in the technique disclosed in PTL 1, when the snapshot volume acquired in the migration source storage node is directly copied and repeatedly migrated to the migration destination storage node, a data transfer amount between the migration source storage node and the migration destination storage node may increase.

The invention has been made in view of the above points, and an object of the invention is to propose a storage apparatus and a storage control method that enable migration of an acquired snapshot volume to a migration destination storage node while reducing a data transfer amount among a plurality of storage nodes.

In order to solve the above problem, the invention provides a storage system including: a first storage node having a primary volume from or to which data is read or written with a host; and a second storage node. Each of the first storage node and the second storage node holds a snapshot volume and a same reference snapshot volume, and the first storage node and the second storage node manage the snapshot volume based on difference data between the reference snapshot volume and the snapshot volume.

Further, the invention provides a storage control method for a storage system including a first storage node having a primary volume from or to which data is read or written with a host, and a second storage node. The storage control method includes: a holding step of holding a snapshot volume and a same reference snapshot volume in each of the first storage node and the second storage node; and a management step of managing the snapshot volume based on difference data between the reference snapshot volume and the snapshot volume by the first storage node and the second storage node.

According to the invention, it is possible to migrate an acquired snapshot volume to a migration destination storage node while reducing a data transfer amount among a plurality of storage nodes.

### BRIEF DESCRIPTION OF THE DRAWINGS

FIG. 1 is a diagram showing a configuration example and an operation example of a storage system including a storage apparatus according to a first embodiment.

FIG. 2 is a diagram showing an example of a data state of a volume related to migration of a snapshot volume shown in FIG. 1.

FIG. 3 is a diagram showing an operation example of restore processing across nodes in the first embodiment.

FIG. 4 is a diagram showing an example of how a reference snapshot is updated.

FIG. 5 is a system configuration diagram showing a physical configuration example of the storage system shown in FIG. 1.

FIG. 6 is a diagram showing a logical configuration of a storage node shown in FIGS. 1 and 5.

FIG. 7 is a diagram showing an example of storage node management information shown in FIG. 6.

FIG. 8 is a diagram showing an example of volume management information shown in FIG. 6.

FIG. 9 is a diagram showing an example of volume control information shown in FIG. 6.

FIG. 10 is a flowchart showing an example of a procedure of snapshot migration processing in the first embodiment.

FIG. 11 is a flowchart showing an example of a procedure of reference snapshot creation processing shown in FIG. 10.

FIG. 12 is a flowchart showing an example of a procedure of reference snapshot update processing shown in FIG. 10.

FIG. 13 is a flowchart showing an example of a procedure of the restore processing in the first embodiment.

FIG. 14 is a diagram showing a configuration example and an operation example of a storage system including a storage apparatus according to a second embodiment.

FIG. 15 is a diagram showing a logical configuration example of a storage node in the second embodiment.

FIG. 16 is a diagram showing an example of volume management information in the second embodiment.

FIG. 17 is a diagram showing volume control information in the second embodiment.

FIG. 18 is a flowchart showing an example of a procedure of reference snapshot creation processing in the second embodiment.

### DESCRIPTION OF EMBODIMENTS

Hereinafter, an embodiment of the invention will be described in detail with reference to the drawings. The following description and drawings are examples for describing the invention, and are omitted and simplified as appropriate for clarification of the description, and do not limit the technical scope of the invention.

In the following description, various kinds of information will be described using expressions such as “structure,” “table”, “form”, “list”, and “queue”, but the various kinds of information may be expressed using a data structure other than the used expressions. Therefore, the information may be simply referred to as “information” to indicate that the information does not depend on a data structure. When describing contents of various kinds of information, expressions such as “identification information”, “identifier”, “name”, “ID”, “number”, and the like are used, but these expressions can be replaced with one another.

In the following description, a “program” may be described as a subject, but since the program executes processing defined by being executed by a processor (for example, a central processing unit (CPU) or a graphics processing unit (GPU)) while appropriately using a storage resource (for example, a memory), an interface device (for example, a communication device), or the like, the processor may be described as the subject. Similarly, a subject of processing performed by executing a program may be a controller, a device, a system, a computer, a node, a storage apparatus, a server, a client, a host, or the like including a processor. Some or all programs may be processed using a hardware circuit.

Various programs may be installed in each computer based on a program distribution server or a storage medium. In the following description, two or more programs may be implemented as one program, or one program may be implemented as two or more programs.

### (1) First Embodiment

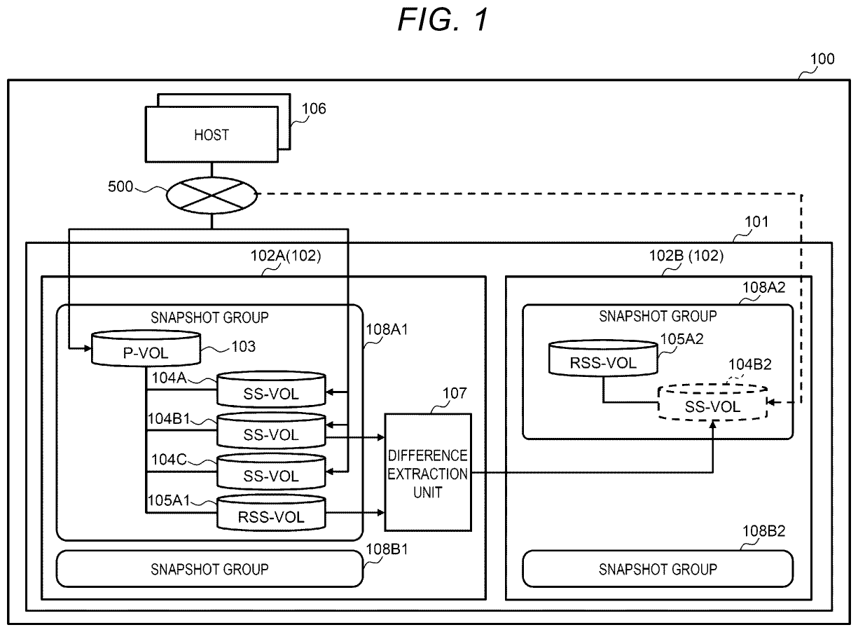

First, a first embodiment will be described with reference to FIGS. 1 to 13.

FIG. 1 is a diagram showing a configuration example and an operation example of a storage system 100 including a storage apparatus 101 according to a first embodiment. The storage system 100 includes the storage apparatus 101 and a plurality of hosts 106. The storage apparatus 101 is implemented by, for example, clustering a plurality of storage nodes 102A and 102B. Each of the storage nodes 102A and 102B provides a logical storage area called a volume to the host 106. When the storage nodes 102A and 102B are not strictly distinguished from each other, they are also referred to as a storage node 102. The host 106 reads and writes data from and to volumes provided from the storage apparatus 101 and the storage node 102 according to various kinds of processing executed in the host 106.

A primary volume (hereinafter also abbreviated as “P-VOL”) 103 is a normal volume. A snapshot can be acquired for the P-VOL 103. A snapshot volume (hereinafter, also abbreviated as “SS-VOL”) 104 is a volume copied using a snapshot function based on the P-VOL 103 and is repeatedly copied according to an instruction from a user or, in some cases, a set condition (whether to acquire a snapshot, an acquisition cycle, and the like). The P-VOL 103 and the SS-VOL 104 are volumes that are provided to the host 106 and can be read and written to or from the host 106. Depending on an implementation form of the snapshot function, there may be the SS-VOL 104 provided with a cascade function that enables acquisition of a snapshot, but this is omitted in the present embodiment. In the shown example, there are three snapshot volumes SS-VOL 104A to SS-VOL 104C for the P-VOL 103 and each of the snapshot volumes receives an IO from the host 106. The example in the drawings shows an operation of migrating the SS-VOL 104B1 from the storage node 102A to the storage node 102B. This migration processing will be described later.

A snapshot group 108 is a group indicating a set of volumes in which data difference management by the snapshot function is performed. In the difference management, a data sharing relation using mapping information is managed. The snapshot group 108 includes one P-VOL 103 or one or more SS-VOLs 104. In the present embodiment, for example, a snapshot group 108A1, a snapshot group 108A2, a snapshot group 108B1, and a snapshot group 108B2 are implemented as snapshot groups across the plurality of storage nodes 102.

A difference extraction unit 107 is a part of the snapshot function, and has a function of extracting a difference area among a plurality of volumes (for example, the P-VOL 103 and the SS-VOL 104) in the snapshot group 108 of a single storage node. The difference area referred to here indicates, for example, an area in which data is different between volumes. Since volumes in the snapshot group 108 of a single storage node are subjected to difference management (management of a data sharing relation using mapping information) by a snapshot function, a difference can be extracted at high speed without comparing entities of data. This function is used in migration processing to be described later.

A reference snapshot volume 105 (hereinafter, also simply referred to as “RSS-VOL”) is a special volume used to implement the snapshot group 108 across the plurality of storage nodes 102 and the difference management in the present embodiment. The RSS-VOL 105 includes one or more RSS-VOLs 105 for each storage node 102 in the snapshot group 108 across the plurality of storage nodes 102. The RSS-VOL 105 is created as a snapshot of any volume in the snapshot group 108 in which the P-VOL 103 is present. The RSS-VOL 105 is copied to the same snapshot group 108 of each storage node 102. The RSS-VOL 105 is a volume that is not provided to the host 106. For the RSS-VOL 105, the same RSS-VOL 105 is guaranteed to store the same data. In the shown example, an RSS-VOL 105A1 present in the snapshot group 108A1 is created as a snapshot of the P-VOL 103. An RSS-VOL 105A2 present in the snapshot group 108A2 is a copy of the RSS-VOL 105A1 and indicates that the same data is stored.

A name of the RSS-VOL 105 includes the word “snapshot”, but the RSS-VOL 105 is not necessarily a snapshot created using the snapshot function. In the shown example, the RSS-VOL 105A1 is a snapshot (a form of a snapshot volume) created using the snapshot function based on the P-VOL 103, but the RSS-VOL 105A2 is a normal volume (a form of a primary volume) created by simply copying data of the RSS-VOL 105A1 between storage nodes.

The storage apparatus 101 according to the present embodiment is a storage apparatus including the first storage node 102A having the P-VOL 103 which is an example of a primary volume from or to which data is read or written with the host 106, and the second storage node 102B. Each of the first storage node 102A and the second storage node 102B stores a snapshot volume, and the first storage node 102A and the second storage node 102B store the RSS-VOL 105A1 and the RSS-VOL 105A2 which are examples of the same reference snapshot volume. That is, the first storage node 102A stores the RSS-VOL 105A1, and the second storage node 102B stores the RSS-VOL 105A2 similar to the RSS-VOL 105A1. The first storage node 102A and the second storage node 102B manage a snapshot volume using difference data between the reference snapshot volume and the snapshot volume. When (any one of) the SS-VOL 104A to 104C which are examples of a snapshot volume of the P-VOL 103 is migrated to the second storage node 102B, for the snapshot volumes SS-VOL 104A to 104C to be migrated, the first storage node 102A extracts difference data between the RSS-VOL 105A1 serving as an example of a first reference snapshot volume which is a reference snapshot volume of the first storage node 102A, and the SS-VOL 104A to 104C which are examples of a snapshot volume to be migrated, and transfers the difference data to the second storage node 102B. The first storage node 102A and the second storage node 102B manage snapshots using the difference data between the RSS-VOL 105A1 and the RSS-VOL 105A2 which are examples of the reference snapshot volume and the SS-VOLs 104A to 104C which are examples of a snapshot volume.

The second storage node 102B uses the transferred difference data and the RSS-VOL 105A2 (second reference snapshot volume) which is a reference snapshot volume of the second storage node 102B to reproduce the snapshot volume to be created in an RSS-VOL 104B2 which is an example of a second snapshot volume.

Next, the migration processing of the SS-VOL 104B1 described above will be described. Since details of the migration processing and restore processing will be described in detail with reference to other drawings, basic operations and principles will be described here.

In order to migrate the SS-VOL 104B1 to a different storage node 102, it is necessary to transfer data stored in the SS-VOL 104B1 to the second storage node 102B in a manner of maintaining the data in the same state. Here, in general migration processing, all data of the SS-VOL 104B1 is transferred from the storage node 102A to the storage node 102B, but in the present embodiment, since the RSS-VOL 105A1 and the RSS-VOL 105A2 in which the same data is guaranteed to be stored in advance are present in the storage nodes 102A and 102B, the migration processing is executed by transferring only difference data between the SS-VOL 104B1 and the RSS-VOL 105A1 by using the RSS-VOL 105A1 and the RSS-VOL 105A2.

More specifically, first, in the second storage node 102B, a snapshot is acquired with the RSS-VOL 105A2 serving as a primary volume, and the snapshot is set as the SS-VOL 104B2. Thereafter, in the first storage node 102A, the difference extraction unit 107 is used to extract a difference area between the SS-VOL 104B1 to be migrated and the RSS-VOL 105A1. Finally, when data related to the extracted difference area is transferred from the SS-VOL 104B1 to the SS-VOL 104B2, the SS-VOL 104B1 and the SS-VOL 104B2 have the same data, and the migration is completed.

In the above-described embodiment, in the migration processing, it is assumed that an IO reception from the host 106 to the SS-VOL 104B1 is temporarily stopped, and the IO reception is resumed using the SS-VOL 104B2 after the migration processing is completed, and the IO reception from the host 106 cannot be performed during the migration processing. In the present embodiment, by copying an IO request received during the migration processing to the SS-VOL 104B1 and the SS-VOL 104B2, it is also possible to perform migration while maintaining IO reception from the host 106. However, since whether to maintain the IO reception is not an essential part of the present embodiment, for example, the following description will be made on the assumption that the IO reception is temporarily stopped.

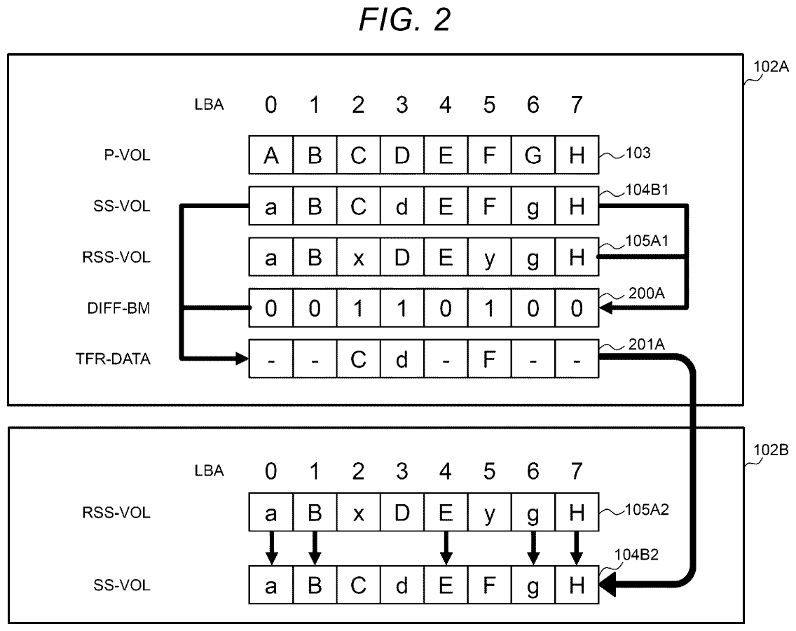

Next, a data flow when a snapshot is migrated will be described with reference to FIG. 2. FIG. 2 is a diagram showing an example of a data state of a volume related to migration of the SS-VOL 104B1 shown in FIG. 1. The P-VOL 103, the SS-VOL 104B1, the SS-VOL 104B2, the RSS-VOL 105A1, and the RSS-VOL 105A2 indicate the same volumes as those in FIG. 1, and represent states (content) of data stored in the volumes each being divided into eight data blocks of logical block addresses (LBA) 0 to 7. Alphabets (including small characters) such as “A”, “B”, and “C” indicate data stored in the respective LBAs. Blocks having the same character indicate that the same data is stored. A large character and a small character indicate different kinds of data.

When a snapshot is migrated, first, a difference area between a migration target snapshot volume and a reference snapshot volume is extracted. A difference area DIFF-BM 0200A represents a difference area between the SS-VOL 104B1 and the RSS-VOL 105A1, which is extracted using the difference extraction unit 107 in a bitmap format (1 bit for each data block to indicate whether there is a difference). A block of “1” indicates that data is different between the SS-VOL 104B1 and the RSS-VOL 105A1. A block of “0” indicates that data is the same.

Next, the bitmap indicating the difference area is used to extract data to be transferred across the plurality of storage nodes 102A and 102B. Specifically, since data of a block with the bitmap of “0” matches data of the reference snapshot volume, it is not necessary to transfer the data across the plurality of storage nodes 102A and 102B, and only data of a block with the bitmap of “1” may be transferred. Data TFR-DATA 0201A indicates data to be transferred from the storage node 102A to the storage node 102B. In the shown example, a block of “-” indicates that transfer is unnecessary. By calculating a logical product of the difference area DIFF-BM 0200A and the SS-VOL 104B1, an area requiring transfer is extracted.

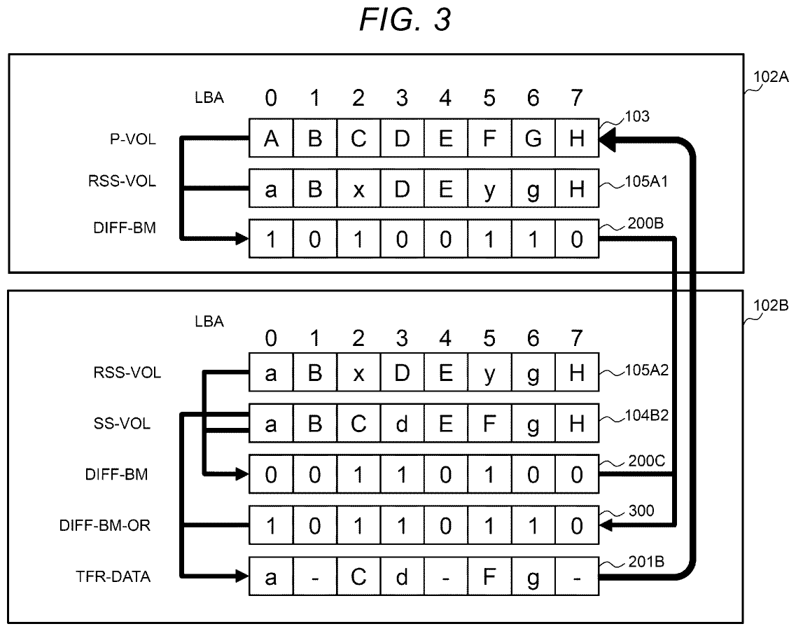

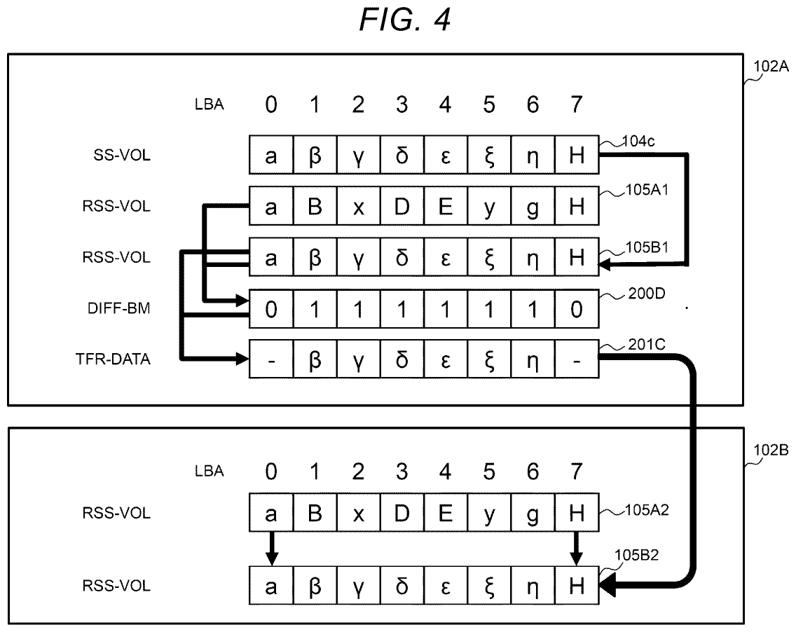

Note that the DIFF-BM 0200A and the TFR-DATA 0201A are areas shown for easy understanding of the data flow during migration, and may not actually exist. Even if the DIFF-BM 0200A and the TFR-DATA 0201A are actually present, they are temporary storage areas (memory or the like) used for data transfer between processing and processing. The same applies to FIGS. 3 and 4 to be described later.

Next, in the second storage node 102B, a migration destination volume (volume for storing data transferred from the storage node 102A) is prepared. In this case, a snapshot of the RSS-VOL 105A2 is acquired and used as the SS-VOL 104B2. At a time point immediately after the creation, the SS-VOL 104B2 has data completely the same as the RSS-VOL 105A2 (and the RSS-VOL 105A1).

Finally, the TFR-DATA 0201A which is data transferred from the storage node 102A1 is written to the SS-VOL 104B2, so that the SS-VOL 104B1 and the SS-VOL 104B2 have the same data, and the migration is completed. Although omitted in the shown example, the SS-VOL 104B1 is deleted from the storage node 102A1 after the migration is completed.

As described above, in the present embodiment, by using the RSS-VOL 105 (A1 and A2 in the shown example), only the difference data (three data blocks of “C”, “d”, and “F” in the shown example) between the RSS-VOL 105 and the SS-VOL 104 to be migrated is transferred among the plurality of storage nodes 102, and thus a snapshot can be migrated across the plurality of storage nodes 102.

Next, a data flow at the time of executing restore processing for restoring data of a primary volume using a snapshot will be described using FIG. 3. FIG. 3 is a diagram showing an example of an operation of restoring the P-VOL 103 across a plurality of storage nodes (making data of the P-VOL 103 match data of the SS-VOL 104B2) by using the SS-VOL 104B2 after a state in which the migration from the SS-VOL 104B1 to the SS-VOL 104B2 is completed according to FIG. 2. The P-VOL 103, the SS-VOL 104B2, the RSS-VOL 105A1, and the RSS-VOL 105A2 are the same as those in FIGS. 1 and 2 described above. Alphabets (including small characters) such as “A”, “B”, and “C” indicate data stored in the respective LBAs. Blocks having the same character indicate that the same data is stored. A large character and a small character indicate different kinds of data.

In the restore processing, the difference extraction unit 107 first extracts a difference area between a reference snapshot and each volume of a restore destination volume and a restore source volume. For example, a difference area DIFF-BM 0200B is an example of first difference data, and represents a difference area between the P-VOL 103 which is a restore source volume and the RSS-VOL 105A1 in a bitmap format. A difference area DIFF-BM 0200C is an example of second difference data, and represents a difference area between the SS-VOL 104B2 which is a restore destination snapshot volume and the RSS-VOL 105A2 in a bitmap format.

Next, the difference extraction unit 107 extracts a difference area between each volume of the restore destination volume and the restore source volume by performing a logical sum of bitmaps indicating the extracted difference areas DIFF-BM 0200B and DIFF-BM 0200C. Specifically, the difference extraction unit 107 transfers the difference area DIFF-BM 0200B from the storage node 102A to the storage node 102B, and performs a logical sum of the difference area DIFF-BM 0200B and the difference area DIFF-BM 0200C in the storage node 102B. A difference area DIFF-BM-OR 0300 indicates a difference area between the P-VOL 103 and the SS-VOL 104B2 obtained as described above in a bitmap format.

That is, the second storage node 102B which is a restore destination specifies an area to be restored and data to be restored by calculating a logical sum of the first difference data and the second difference data, in which the first difference data is a bitmap indicating a difference area between the P-VOL 103 which is an example of a primary volume and the RSS-VOL 105A1 which is an example of a first reference snapshot, and the second difference data is a bitmap indicating a difference area between the RSS-VOL 105A2 which is an example of a second reference snapshot volume and the SS-VOL 104B2 which is an example of a second snapshot volume in the second storage node 102B which is a restore destination.

In the above-described embodiment, the difference extraction unit 107 indirectly extracts the difference area between the SS-VOL 104B2 and the P-VOL 103 by using the RSS-VOLs 105A1 and 105A2. This is because, in order to directly compare the SS-VOL 104B2 and the P-VOL 103, it is necessary to transfer all data of the P-VOL 103 from the first storage node 102A to the second storage node 102B and then compare entities of the data. As described above in the description of the difference extraction unit 107, since difference management (management of a data sharing relation using the mapping information) by the snapshot function is performed between volumes in the snapshot group 108 of a single storage node, a difference can be extracted at high speed without comparing entities of data. A bitmap represents the presence or absence of a difference by 1 bit for each data block. In this manner, even if data is transferred among a plurality of storage nodes, a data amount can be reduced.

Next, data to be transferred across storage nodes is extracted using a bitmap indicating a difference area. TFR-DATA 0201B is obtained by calculating the logical product of the difference areas DIFF-BM-OR 0300 and the SS-VOL 104B2. The TFR-DATA 0201B indicates data to be transferred from the storage node 102B to the P-VOL 103 of the storage node 102A. A block of “-” indicates that transfer is unnecessary.

Finally, the storage node 102B transfers the data of the TFR-DATA 0201B to the first storage node 102A, and the first storage node 102A writes the transferred data to the P-VOL 103 so that the SS-VOL 104B2 and the P-VOL 103 have the same data, and the restore processing is completed. In the shown example, a state at a restoration completion time point is omitted.

As described above, in the present embodiment, by using the RSS-VOL 105 (corresponding to the RSS-VOLs 105A1 and 105A2 in the shown example), only the difference data between the RSS-VOL 105 and each volume of the restore source volume and the restore destination volume is transferred among the plurality of storage nodes 102, and thus the restore processing can be executed across the storage nodes 102. The difference data referred to here is five data blocks of “a”, “C”, “d”, “F”, and “g” in the shown example.

Referring to the drawing, it can be seen that the same data (“C” and “F”, respectively) is stored in the blocks with the LBAs “2” and “5” in the SS-VOL 104B2 and the P-VOL 103 and the data does not need to be transferred across the plurality of storage nodes 102A and 102B. However, the difference area is actually extracted, and if the present embodiment is not applied, unnecessary transfer occurs. This is because the difference area between the SS-VOL 104B2 and the P-VOL 103 is indirectly extracted by performing a logical sum of results obtained by comparing each volume with the RSS-VOL 105, and thus if there is a difference between each volume and the RSS-VOL 105, even if the SS-VOL 104B2 and the P-VOL 103 actually match with each other, a difference is extracted.

Here, in a case where the present embodiment is not applied, it is necessary to directly compare the SS-VOL 104B2 and the P-VOL 103 in order to eliminate the unnecessary transfer, but in this case, as described above, it is necessary to transfer all data of the P-VOL 103 and there is a concern that a transfer amount may increase. That is, the unnecessary transfer is overhead in the present embodiment. The overhead tends to decrease as a difference between each volume and the RSS-VOL 105 decreases, and on the other hand, the overhead tends to increase as the difference increases. Since the RSS-VOL 105 is a volume that is not provided to the host 106, data does not change, and on the other hand, since the P-VOL 103 and the SS-VOL 104 are provided to the host 106 and are read and written, data changes over time. That is, the overhead increases over time, and there is a concern that a result is finally the same as a general method of transferring all data of a volume.

Therefore, in the present embodiment, when the difference data between a volume to be processed and the RSS-VOL 105 is larger than a certain value, the RSS-VOL 105 is updated to keep the difference data equal to or smaller than the certain value.

Specifically, in the second storage node 102B, when a deviation between the RSS-VOL 105A1 which is an example of the first reference snapshot and each of the snapshot volumes 104A to 104C (for example, the created latest snapshot volume 104C) is larger than a predetermined threshold, the first storage node 102A and the second storage node 102B update the RSS-VOL 105A1 included in each of the first storage node 102A and the second storage node 102B and hold the same updated RSS-VOL 105A1.

Further, the first storage node 102A continues to copy only the difference data to the second storage node 102B until the deviation becomes larger than the predetermined threshold.

The first storage node 102A repeatedly creates a snapshot volume and holds the plurality of snapshot volumes 104A to 104C for each generation, and when the deviation between the created snapshot volume, for example, the latest snapshot volume 104C, and the RSS-VOL 105A1 becomes larger than the predetermined threshold, the first storage node 102A and the second storage node 102B update the RSS-VOL 105A1 included in each of the first storage node 102A and the second storage node 102B and hold the same updated RSS-VOL 105A1. Further, in the present embodiment, when a reference snapshot volume is updated, the first storage node 102A updates the RSS-VOL 105A1 which is an example of the first reference snapshot volume and transmits updated difference data with the RSS-VOL 105A1 to the second storage node 102B, and the second storage node 102B updates the second reference snapshot volume RSS-VOL 105A2 using the updated difference data with the RSS-VOL 105A1.

Although not described with reference to FIG. 2, when a snapshot is to be migrated, if a difference between the snapshot to be migrated and the RSS-VOL 105 is large, a data amount to be transferred increases. Therefore, the update of the RSS-VOL 105 is processing necessary for migration of a snapshot.

The first storage node 102A creates a first bitmap indicating the presence or absence of a difference between a storage area of the RSS-VOL 105A1 serving as an example of the first reference snapshot volume which is a reference snapshot volume of the first storage node 102A, and a storage area of the SS-VOL 104B1 which is an example of a first snapshot volume stored in the first storage node 102A. The second storage node 102B creates a second bitmap indicating the presence or absence of a difference between a storage area of the RSS-VOL 105A2 serving as an example of a second reference snapshot volume which is a reference snapshot volume of the second storage node 102B, and a storage area of the SS-VOL 104B2 which is an example of a second snapshot volume stored in the second storage node. When the second snapshot volume stored in the second storage node 102B is restored to the first storage node 102A, the second storage node 102B determines and transfers data to be transferred to the first storage node 102A among data of the second snapshot volume based on the first bitmap and the second bitmap. The first storage node 102A restores the SS-VOL 104B2 which is an example of the second snapshot volume by using the transferred data of the SS-VOL 104B2 which is an example of the second snapshot volume, the RSS-VOL 105A1 which is an example of the first reference snapshot volume, and the SS-VOL 104B1 which is an example of the first snapshot volume.

FIG. 4 is a diagram showing an example of how the RSS-VOL 105 is updated. In the shown example, a state is shown in which a difference between the originally existing RSS-VOL 105A1 and RSS-VOL 105A2 and the SS-VOL 104C to be processed is large, and if processing such as migration and restoration is performed in this state, the transfer overhead described above becomes large. The example shows an operation of creating (or updating) a new RSS-VOL 105B1 and a new RSS-VOL 105B2 from this state. Alphabets such as “a”, “B”, and “γ” indicate data stored in respective LBAs regardless of small characters, large characters, and Greek characters, and indicate that the same data is stored in blocks having the same character. Note that different character types indicate different data.

When the RSS-VOL 105 is updated, first, in any one of the storage nodes 102, a volume that is a source of the new RSS-VOL 105 is selected, and a snapshot of the volume is acquired to create the new RSS-VOL 105. In the shown example, in the storage node 102A, the SS-VOL 104C is selected, and the new RSS-VOL 105B1 is created from the SS-VOL 104C. A volume can be freely selected as long as the volume is, for example, in the snapshot group 108. However, with regard to the selection of a volume, for example, in consideration of the purpose of update processing, it is basic to select a volume in which the overhead is small in migration processing or restore processing to be executed in the future, such as selecting a volume to be processed most recently.

Next, the new RSS-VOL 105 is copied to each storage node 102. In this processing, basically, the snapshot migration processing described with reference to FIG. 2 is executed only on the new RSS-VOL 105 as a migration target. Specifically, first, a difference area DIFF-BM 0200D between the old RSS-VOL 105 and the new RSS-VOL 105, that is, the difference area DIFF-BM 0200D between the RSS-VOL 105A1 and the RSS-VOL 105B1 is extracted. Next, an area TFR-DATA 0201C that needs to be transferred is extracted by calculating a logical product of the difference area DIFF-BM 0200D and the new RSS-VOL 105B1. Next, in the storage node 102B which is a copy destination, the RSS-VOL 105B2 is created as a snapshot of the old RSS-VOL 105A2 as a volume of a copy destination, and the RSS-VOL 105B2 is set as a new reference snapshot volume. Finally, data of the area TFR-DATA 0201C that needs to be transferred is transferred from the storage node 102A to the RSS-VOL 105B2 of the storage node 102B, thereby copying the new reference snapshot volume. Since this processing is not migration but copying, the copy source RSS-VOL 105B1 is not deleted.

Update processing of a reference snapshot is completed according to the contents described above, and thereafter, the migration processing and the restore processing described in FIGS. 2 and 3 may be executed using the newly created RSS-VOL 105B1 and 105B2.

The old RSS-VOL 105A1 and 105A2 may be deleted or may be left without being deleted. In a case where the old RSS-VOL 105A1 and 105A2 are left, a storage capacity of the old reference snapshot volumes is consumed in each storage node 102, but if difference data of the old reference snapshot is smaller than the difference data of the new reference snapshot when the migration processing and the restore processing are executed, there is a possibility that the overhead can be reduced by intentionally using the old reference snapshot.

On the other hand, in a case where the old RSS-VOL 105A1 and 105A2 are deleted, the old RSS-VOL 105A1 and 105A2 may be deleted only in some of the storage nodes 102. At this time, in the first storage node 102A or the second storage node 102B from which the old RSS-VOL 105A1 or RSS-VOL 105A2 is deleted, when the RSS-VOL 105A1 and RSS-VOL 105A2 are required later, the old RSS-VOL 105A1 and RSS-VOL 105A2 can be recreated by transferring difference data between old and new reference snapshot volumes from the storage node 102 having both the old RSS-VOL 105A1 and RSS-VOL 105B1 or both the RSS-VOL 105A2 and RSS-VOL 105B2.

In the present embodiment described above, an operation principle was described focusing on a data flow. Hereinafter, the storage system 100 and the storage apparatus 101 that achieve such a data flow and operation will be described. Note that the snapshot migration processing and the restore processing described above are merely utilization examples of difference management across a plurality of storage nodes 102A and 102B implemented by providing a reference snapshot, and the invention is not limited to the present embodiment.

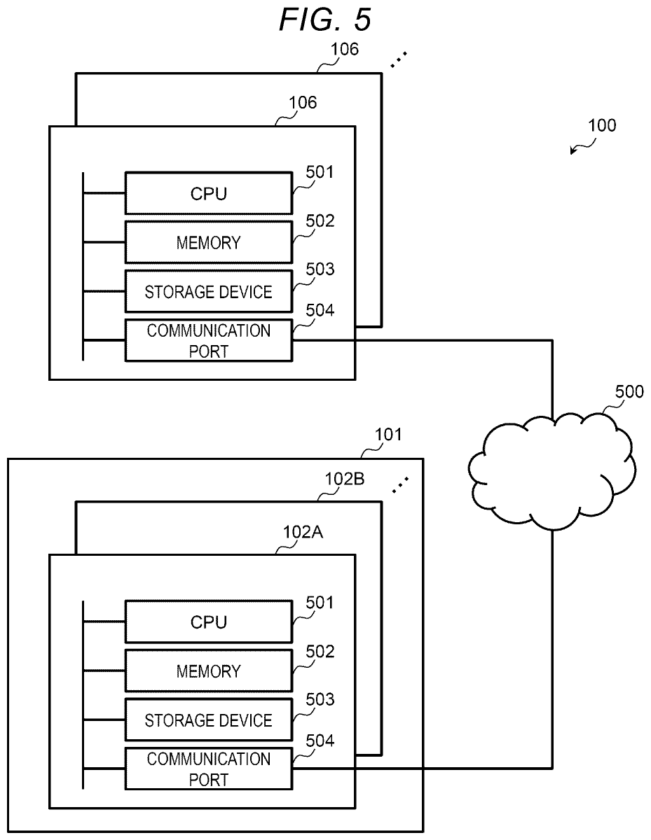

FIG. 5 is a system configuration diagram showing a physical configuration example of the storage system 100 shown in FIG. 1. The storage system 100 includes the storage apparatus 101 and at least one host 106. The storage apparatus 101 includes two or more storage nodes 102 (102A and 102B). It is not necessary to install various components constituting the storage system 100 at the same location. For example, the storage apparatus 101 and the host 106 may be installed in different data centers. Similarly, a plurality of components constituting the storage system 100 may be physically constituted by one device. For example, such as a hyper converged infrastructure (HCI), a function as the storage node 102 and a function as the host 106 may be configured to coexist in one physical server. The storage apparatus 101 implemented by clustering the storage nodes 102 may be treated as one storage node 102 to configure a further large-scale and hierarchical storage apparatus 101.

Each of the storage node 102 and the host 106 is a computer including a CPU 501, a memory 502, a storage device 503, and a communication port 504, but a strict configuration is not limited as long as the storage node 102 and the host 106 can play respective roles described later. Each of the storage node 102 and the host 106 may include a plurality of components or may include components other than those described above. For example, each of the storage node 102 and the host 106 may be made redundant by mounting a plurality of hard disk drives as the storage device 503, or may be mounted with an accelerator such as a graphics processing unit (GPU) in order to substitute for a part of processing executed by the CPU 501. Each component may be virtual hardware based on a virtualization technique such as a virtual machine or a container instead of physical hardware. Similarly, a service that executes a program regardless of an actual computing environment, such as Function-as-a-Service or Serverless Computing, may be used.

The components constituting the storage system 100 are connected to a network 500 and can communicate with one another. The network 500 is implemented by any communication line such as Ethernet (registered trademark), InfiniBand, or an optical fiber, and a combination thereof. The network 500 may include not only a local area network (LAN) closed in a data center but also a wide area network (WAN) such as the Internet and a virtual network inside a computer. Although not shown, the network 500 may include network devices such as a network switch, a router, and a gateway as necessary. In the shown example, all the components are connected to one network 500, but a dedicated network used between specific components may be provided. For example, the network 500 may include a dedicated network in order to speed up communication between the storage nodes 102.

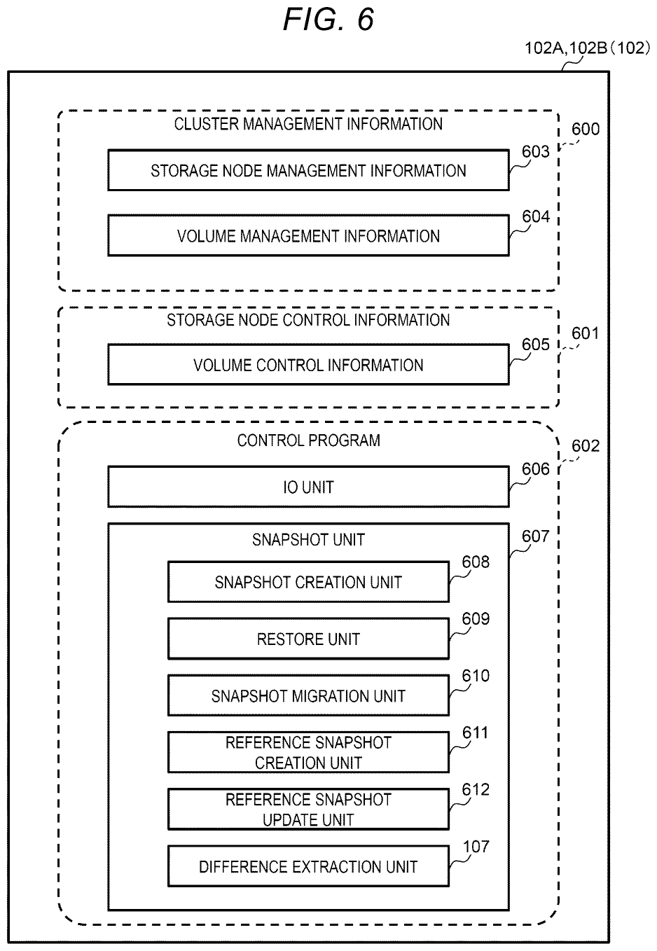

FIG. 6 is a diagram showing a logical configuration of the storage node 102 shown in FIGS. 1 and 5. Each of the storage nodes 102 constituting the storage apparatus 101 includes cluster management information 600, storage node control information 601, and a control program 602.

The cluster management information 600 is management information for clustering a plurality of storage nodes 102 to operate as one storage apparatus 101. The cluster management information 600 includes storage node management information 603 and volume management information 604. The storage node management information 603 is information for managing the storage nodes 102 constituting the storage apparatus 101. The volume management information 604 is information for managing a configuration of a volume and a snapshot managed by the storage apparatus 101. The cluster management information 600 may be actually held by all the storage nodes 102 constituting the storage apparatus 101, or may be held only by the representative storage node 102.

The storage node control information 601 is control information used by the control program 602 operating in the storage node 102 to execute IO processing to a volume and an operation of a snapshot function. The storage node control information 601 is information unique to each storage node 102. The storage node control information 601 includes volume control information 605. Although omitted in the shown example, the storage node control information 601 may further include, for example, information for controlling the storage device 503 and information for controlling the communication port 504. The volume control information 605 is control information necessary for IO processing to a volume and an operation of a snapshot function.

The control program 602 is a program for achieving the IO processing to a volume and the operation of a snapshot function by controlling the storage device 503 and the communication port 504 of the storage node 102 using the storage node control information 601. The control program 602 includes an IO unit 606 and a snapshot unit 607. The IO unit 606 is a program that processes an IO request for a volume that is a logical storage area, and has a function of reading and writing desired data from and to the storage device 503 in response to the IO request. Although only the host 106 generally requests an IO to the IO unit, the snapshot unit 607 may request an IO in the present embodiment. The snapshot unit 607 is a function group for achieving a snapshot function. The control program 602 includes a snapshot creation unit 608, a restore unit 609, a snapshot migration unit 610, a reference snapshot creation unit 611, a reference snapshot update unit 612, and the difference extraction unit 107.

The snapshot creation unit 608 has a function of creating the new SS-VOL 104 based on the designated P-VOL 103. The restore unit 609 has a function of implementing restore processing of restoring data of a volume in the snapshot group 108 using a designated volume. The snapshot migration unit 610 has a function of implementing processing of migrating the designated SS-VOL 104 to another storage node 102. The reference snapshot creation unit 611 has a function of creating a new reference snapshot from a state in which no reference snapshot is present in the snapshot group 108. The reference snapshot update unit 612 has a function of creating a new reference snapshot from a state in which a reference snapshot is already present in the snapshot group 108. The difference extraction unit 107 has a function of extracting a difference area between volumes in the snapshot group 108 of the same node.

The configuration of the control program 602 in the present embodiment is subdivided in consideration of ease of description, and an actual structure may be significantly different. For example, in IO processing for a volume to which the snapshot function is applied, the IO unit 606 and the snapshot unit 607 need to closely cooperate with each other, and actually, the control program 602 may not be clearly divided into the two functions.

The storage system 100 may have various functions in addition to the snapshot function, but these functions are omitted here for simplification of the description. Further, the description of the IO unit 606 and the snapshot unit 607 that are not related to the essence of the present embodiment will be omitted. In addition, a function of transmitting and receiving data among the plurality of storage nodes 102, a function of receiving an instruction from a user, a function of maintaining information such as the storage node management information 603 and the volume management information 604 in a latest state, and the like are also omitted. The cluster management information 600 and the storage node control information 601 may also include various kinds of information for each function omitted in the present embodiment.

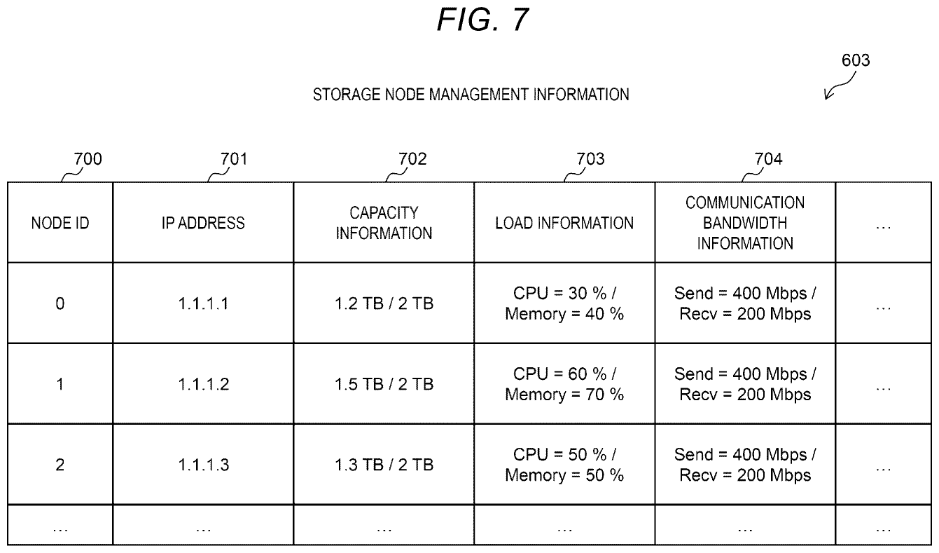

FIG. 7 is a diagram showing an example of the storage node management information 603 shown in FIG. 6. The storage node management information 603 is information for managing the plurality of storage nodes 102 constituting the storage apparatus 101. Each entry of the storage node management information 603 includes a node ID 700, an IP address 701, capacity information 702, load information 703, and communication bandwidth information 704.

The node ID 700 is information for uniquely identifying each of the plurality of storage nodes 102 in the storage apparatus 101. In the shown example, the node ID 700 is a serial number, but may not be a serial number, and may be, for example, an ID using a character other than a number. The IP address 701 is connection destination information used for communication between the storage nodes 102 or for the host 106 to access a volume provided by the storage node 102. In the shown example, each storage node 102 has one IP address, but when the storage node 102 has a plurality of the communication ports 504, the storage node 102 may have connection information for each of the communication ports 504. The capacity information 702 is information indicating a total capacity and a used capacity of a storage capacity that the storage node 102 can provide to the host 106. The load information 703 is information indicating a usage status of a calculation resource consumed by the storage node 102 for IO processing to a volume or the like. Examples of the calculation resource include the CPU 501 and the memory 502. The communication bandwidth information 704 is information indicating a usage status of the communication port 504 consumed by the storage node 102 for IO processing from the host 106 to a volume, snapshot migration processing, and the like.

In the shown example, in the storage node 102 with the node ID 700 of “0”, the IP address 701 is “1.1.1.1”, and a total storage capacity is “2 TB”. Among the total capacity, “1.2 TB” is used, “30%” of the CPU 501 is used for IO processing, and the like, and “40%” of the memory 502 is used. For the communication port 504, “400 Mbps” is used in a transmission direction, and “200 Mbps” is used in a reception direction.

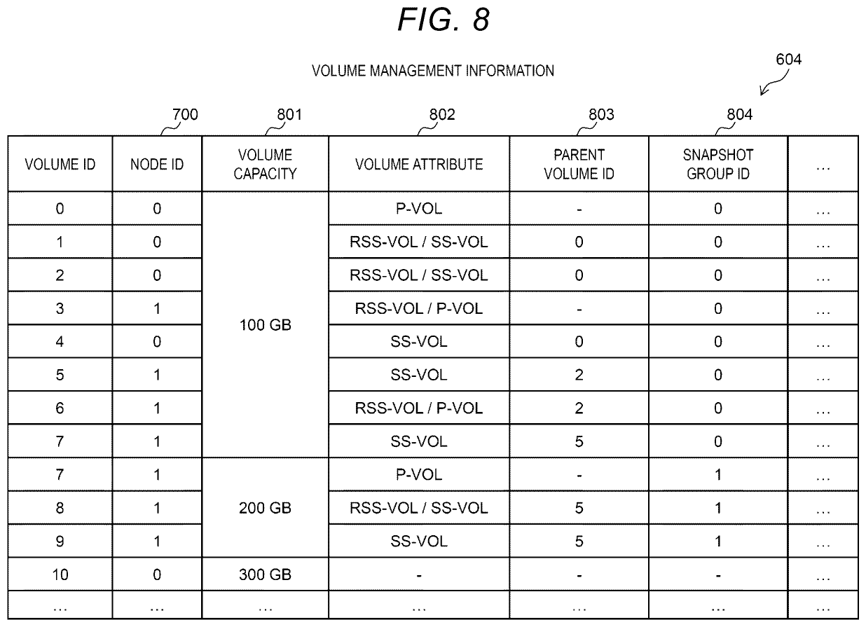

FIG. 8 is a diagram showing an example of the volume management information 604 shown in FIG. 6. The volume management information 604 is information for managing a configuration of a volume and a snapshot managed by the storage apparatus 101. Each entry of the volume management information 604 includes a volume ID 800, the node ID 700, a volume capacity 801, a volume attribute 802, a parent volume ID 803, and a snapshot group ID 804.

The volume ID 800 is information for uniquely identifying a volume in the storage apparatus 101. In the shown example, the volume ID 800 is a serial number, but may not be a serial number, and may be an ID using a character other than a number. The node ID 700 is information indicating an ID of the storage node 102 in which the volume is stored. The volume capacity 801 is information indicating a storage capacity of the volume.

The volume attribute 802 is information indicating that the volume is used for what kind of application. “P-VOL” indicates that a snapshot function is applied to the volume and the volume is the P-VOL 103. “SS-VOL” indicates that a snapshot function is applied to the volume and the volume is the SS-VOL 104. “RSS-VOL” indicates that a snapshot function is applied to the volume and the volume is a reference snapshot. “-” indicates that a function such as a snapshot function is not applied to the volume and the volume is a normal volume. A plurality of values may be set in the volume attribute 802. For example, “RSS-VOL/SS-VOL” indicates that the volume is a reference snapshot volume and is a snapshot volume created using a snapshot function based on the P-VOL 103.

The parent volume ID 803 is information indicating an ID of the P-VOL 103 that is a source of a snapshot when the volume is a snapshot volume, that is, for example, when the volume has “SS-VOL” as the volume attribute 802. When the volume is a primary volume and when the volume is a normal volume to which the snapshot function is not applied, “-” is stored in the parent volume ID 803.

The snapshot group ID 804 is information for uniquely identifying the snapshot group 108 to which the volume belongs. In the shown example, the snapshot group ID 804 is a serial number, but may not be a serial number, and may be an ID using a character other than a number. When the volume is a normal volume to which the snapshot function is not applied, “-” is stored in the snapshot group ID 804. The snapshot group ID 804 is newly numbered when a first snapshot is acquired with a normal volume to which the snapshot function is not applied as a primary volume.

In the shown example, a volume with the volume ID 800 of “0” is stored in the storage node 102 with the node ID 700 of “0”,has a storage capacity of “100 GB”, is used as a primary volume in the snapshot function, and belongs to the snapshot group 108 with the snapshot group ID 804 of “0”.

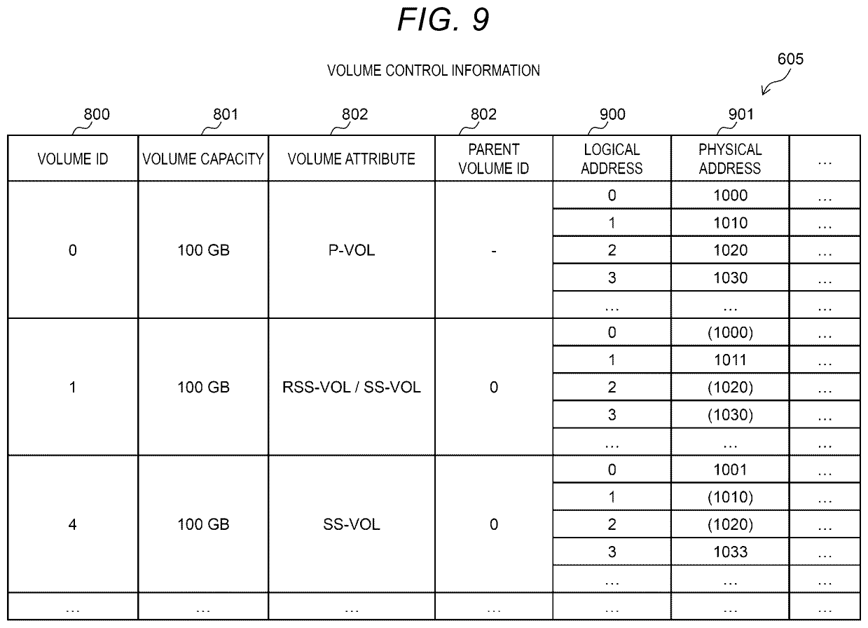

FIG. 9 is a diagram showing an example of the volume control information 605 shown in FIG. 6. The volume control information 605 is control information used by the control program 602 operating in the storage node 102 to execute IO processing to a volume and an operation of a snapshot function. The volume control information 605 is information unique to each storage node 102. Each entry of the volume control information 605 includes the volume ID 800, the volume capacity 801, the volume attribute 802, the parent volume ID 803, a logical address 900, and a physical address 901.

The ID 800, the volume capacity 801, the volume attribute 802, and the parent volume ID 803 of the volume control information 605 are respectively the same as the ID 800, the volume capacity 801, the volume attribute 802, and the parent volume ID 803 of the volume management information 604 described above. The logical address 900 indicates a storage position of logical data in a logical storage area which is a volume read and written by the host 106, and the physical address 901 indicates a storage position of physical data when the logical data is physically stored in the storage device 503. The logical address 900 and the physical address 901 are used as information for managing a correspondence relation between logical data and physical data by combining information of the logical address 900 and the physical address 901. When a volume is a snapshot volume, that is, when the volume has “SS-VOL” as the volume attribute 802, the physical address 901 has a parenthesis such as “(1000)”. The parenthesis indicates that data of the logical address 900 is shared with a primary volume indicated by the parent volume ID 803.

Generally, immediately after a snapshot is acquired, the entire area of a snapshot volume is shared with a primary volume, and thereafter, the host 106 writes data to the snapshot volume and the primary volume, thereby canceling the sharing. A method of managing mapping information and actual data in such a snapshot function is implemented using a control method such as copy on write or redirect on write. A method of managing a correspondence relation between logic and physical data such as the logical address 900 and the physical address 901 may be changed depending on these control methods and execution methods, but description for such a change will be omitted.

In the shown example, a volume with the volume ID 800 of “1” has a storage capacity of “100 GB”, has “RSS-VOL/SS-VOL” as the volume attribute 802, and is a volume created as a snapshot of a primary volume with the volume ID 800 of “0”. A data block with the logical address 900 of “0” shares data with the primary volume, and is stored in an area with the physical address 901 of “1000”. A data block with the logical address 900 of “1” is stored in an area with the physical address 901 of “1011”. A data block with the logical address 900 of “2” shares data with the primary volume, and is stored in an area with the physical address 901 of “1020”. A data block with the logical address 900 of “3” shares data with the primary volume, and is stored in an area with the physical address 901 of “1030”.

Various kinds of information handled by the storage system 100 including the storage apparatus 101 in the present embodiment have been described above. In the embodiment described above, information is not limited to the information described above, and new information may be added as necessary, or unnecessary information may be deleted. In the following description, main processing contents of each function constituting the control program 602 will be described.

First, a storage control method according to the present embodiment will be described. The storage control method according to the present embodiment is a storage control method for the storage system 100 including the second storage node 102B and the first storage node 102A having the P-VOL 103 to or from which data is read and written with the host 106, and the storage control method includes: a holding step of holding snapshot volumes and the same reference snapshot volumes RSS-VOL 105A1 and RSS-VOL 105A2 in the first storage node 102A and the second storage node 102B; and a management step of managing the snapshot volumes according to difference data between the first reference snapshot volume RSS-VOL 105A1 which is an example of a reference snapshot volume and (any one of) the snapshot volumes SS-VOL 104A to 104C by the first storage node 102A and the second storage node 102B.

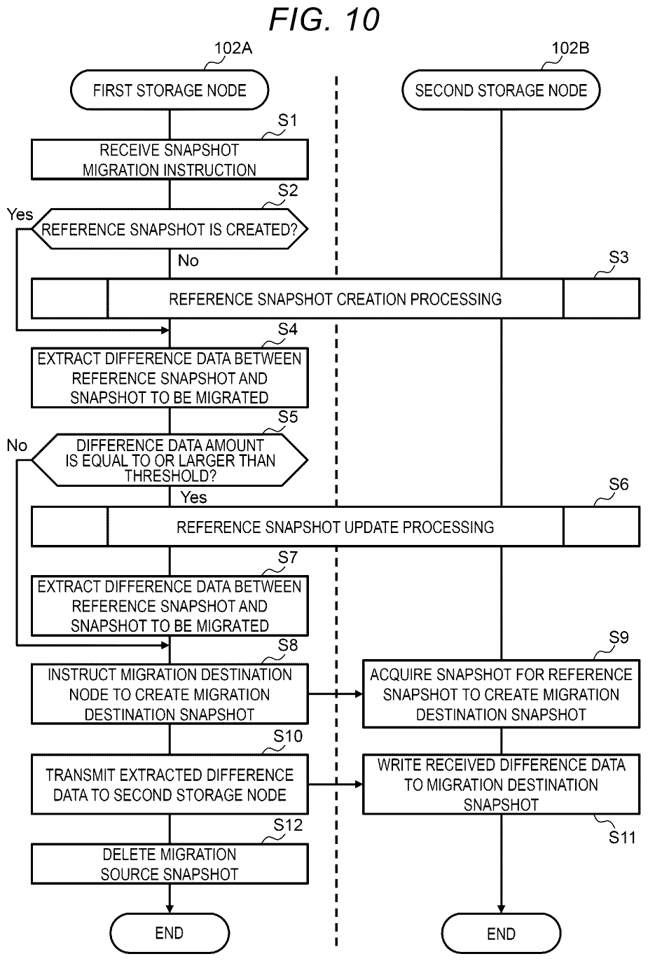

FIG. 10 is a flowchart showing an example of a procedure of snapshot migration processing according to the first embodiment. The snapshot migration processing is executed by a user instructing the storage apparatus 101 to migrate the SS-VOL 104 and activating the snapshot migration unit 610. Alternatively, instead, the snapshot migration processing may be autonomously executed so as to eliminate a bias when one function of control program 602 in the storage apparatus 101 periodically monitors at least one of the capacity information 702 and the load information 703 of the storage node management information 603 and detects a bias in at least one of a storage capacity and a calculation load.

In the snapshot migration processing, first, the first storage node 102A in which the SS-VOL 104 to be migrated is present receives a snapshot migration instruction (step S1). The migration instruction includes the volume ID 800 of the SS-VOL 104 to be migrated and the node ID 700 of the second storage node 102B.

Next, the snapshot migration unit 610 of the first storage node 102A refers to the volume management information 604 to determine whether the RSS-VOL 105 is present in the snapshot group 108 to which the SS-VOL 104 to be migrated belongs (step S2). The snapshot migration unit 610 performs step S3 when there is no RSS-VOL 105, and performs step S4 when the RSS-VOL 105 is present.

In step S3, the reference snapshot creation unit 611 is called, and the reference snapshot creation unit 611 executes reference snapshot creation processing. In the reference snapshot creation processing, the reference snapshot creation unit 611 creates the new RSS-VOL 105 in the first storage node 102A and the second storage node 102B. Details of the reference snapshot creation processing will be described later.

In step S4, the difference extraction unit 107 extracts difference data between the RSS-VOL 105 and the SS-VOL 104 to be migrated. Step S4 corresponds to the processing of extracting the difference areas DIFF-BM 0200A and TFR-DATA 0201A in FIG. 2 described above. The difference extraction unit 107 exhibits a part of a basic function of a so-called snapshot function. Details are omitted, and the difference extraction unit 107 refers to the volume control information 605 and compares the physical addresses 901 for the same logical address 900 between volumes for which a difference is to be extracted, thereby extracting the difference.

In the present embodiment, when there are a plurality of RSS-VOLs 105, step S4 is performed for each RSS-VOL 105, and the specific RSS-VOL 105 having smallest difference data is adopted.

Next, the difference extraction unit 107 determines whether a data amount of the extracted difference data is equal to or larger than a predetermined threshold (step S5). When the data amount of the extracted difference data is equal to or larger than the predetermined threshold, step S6 is executed. On the other hand, when the data amount of the extracted difference data is less than the predetermined threshold, step S8 is executed. Such determination is processing for reducing the overhead of transfer between the plurality of storage nodes 102A and 102B to fall within a predetermined range. The threshold is basically set by a ratio to the volume capacity 801, but the threshold may be set by a different method. The threshold may be dynamically adjusted, and may be adjusted with reference to, for example, the capacity information 702, the load information 703, and the communication bandwidth information 704.

In step S6, the reference snapshot update unit 612 is called, and executes reference snapshot update processing. In the reference snapshot update processing, the reference snapshot update unit 612 updates the RSS-VOL 105 so as to reduce the transfer overhead. Details of the reference snapshot update will be described later. When the update of the RSS-VOL 105 is completed, the difference extraction unit 107 extracts again difference data between the RSS-VOL 105 and the SS-VOL 104 to be migrated using the updated RSS-VOL 105 (step S7). The processing is the same as that in step S4. When the extraction of the difference data is completed, step S8 is executed.

In step S8, the reference snapshot update unit 612 instructs the second storage node 102B to create the SS-VOL 104 from the first storage node 102A. The second storage node 102B that received the instruction creates the SS-VOL 104 by acquiring a snapshot of the RSS-VOL 105 (step S9).

Next, the first storage node 102A reads the difference data extracted in step S4 or step S7 from the SS-VOL 104 to be migrated and transmits the difference data to the second storage node 102B (step S10). The second storage node 102B writes the received difference data to the SS-VOL 104 created in step S9 (step S11). At this time, the reading and writing of data from and to the SS-VOL 104 in the first storage node 102A and the second storage node 102B are implemented by the snapshot migration unit 610 issuing, to the IO unit 606, an IO request to a volume in the same manner as the host 106 reads and writes data from and to the volume.

Finally, the first storage node 102A deletes the migration source SS-VOL 104 (step S12).

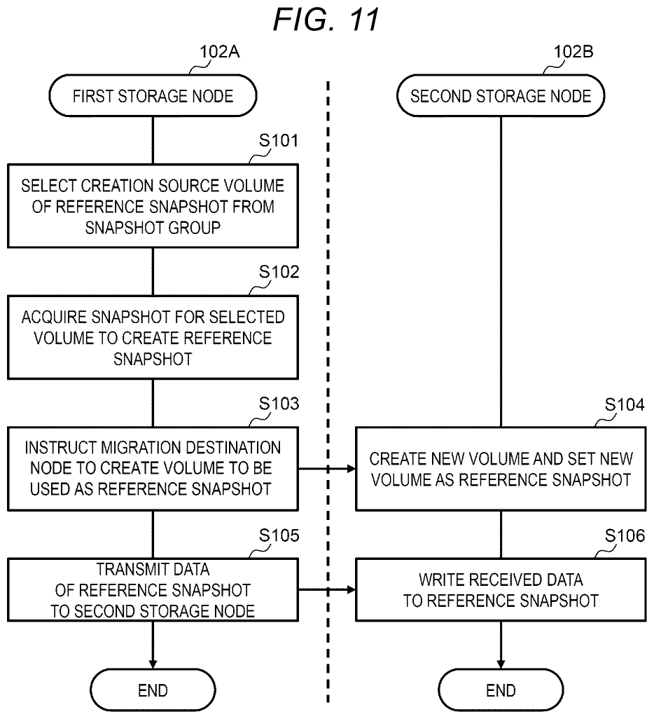

FIG. 11 is a flowchart showing an example of a procedure of the reference snapshot creation processing shown in FIG. 10. The reference snapshot creation processing is executed by the snapshot migration unit 610.

In step S101, first, the snapshot migration unit 610 selects a volume that is a source of a reference snapshot volume in the snapshot group 108 and the storage node 102A, to which the SS-VOL 104 to be migrated belongs. Although the P-VOL 103 is basically used as the volume to be selected, any volume may be used as long as it is a volume in the snapshot group 108 and the storage node 102.

For example, the snapshot migration unit 610 may select the SS-VOL 104 to be migrated, may select the oldest SS-VOL 104, or may select the newest SS-VOL 104. Furthermore, when it is assumed that all the SS-VOLs 104 belonging to the first storage node 102A are to be migrated using the volume control information 605, the snapshot migration unit 610 may newly create the SS-VOL 104 having mapping of the physical address 901 and the logical address 900 such that a difference data amount to be transferred is smallest.

Next, the snapshot migration unit 610 creates a snapshot for the selected volume, and sets the snapshot as the RSS-VOL 105 in the first storage node 102A (step S102).

Next, the snapshot migration unit 610 instructs the second storage node 102B to create a volume to be used as the RSS-VOL 105 from the first storage node 102A (step S103). The second storage node 102B that received the instruction creates a new volume and sets the new volume as the RSS-VOL 105 in the second storage node 102B (step S104).

Finally, the snapshot migration unit 610 reads and transmits all data of the RSS-VOL 105 created in step S102 from the first storage node 102A to the second storage node 102B (step S105), and the second storage node 102B writes the received data to the RSS-VOL 105 created in step S104 (step S106). The reading and writing of data from and to the RSS-VOL 105 at this time is implemented by the snapshot migration unit 610 issuing, to the IO unit 606, an IO request to a volume in the same manner as the host 106 reads and writes data from and to the volume.

The above-described embodiment describes an operation in a case where there is no RSS-VOL 105 in the storage node 102, that is, neither in the first storage node 102A nor in the second storage node 102B. In the storage apparatus 101 with three or more of the storage nodes 102, there may be a state in which the RSS-VOL 105 is already present in one of the first storage node 102A and the second storage node 102B. In this case, step S101 and step S102 described above may be omitted, and processing such as transferring data from the storage node 102 in which the RSS-VOL 105 is present to the storage node 102 in which the RSS-VOL 105 is not present may be executed. In addition, in the storage apparatus 101 with three or more of the storage nodes 102, the processing of step S103 to step S106 may be executed on the storage nodes 102 other than the second storage node.

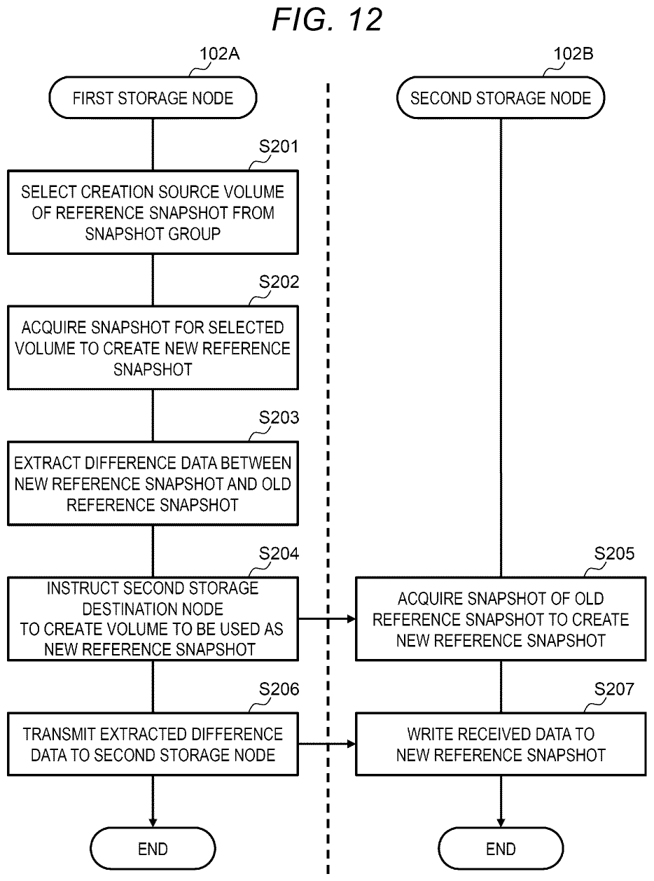

FIG. 12 is a flowchart showing an example of a procedure of the reference snapshot update processing shown in FIG. 10. The reference snapshot update processing is executed by calling the reference snapshot update unit 612 from the snapshot migration unit 610 or the restore unit 609. When the reference snapshot update processing is called from the restore unit 609, terms “migration target”, “migration source (first)”, and “migration destination (second)” can be replaced with “restore target”, “restore source”, and “restore destination”, respectively, in the drawings and the following description.

In the reference snapshot update processing, first, the reference snapshot update unit 612 selects a volume that is a source of a new reference snapshot volume from the snapshot group 108 and the storage node 102, to which the SS-VOL 104 to be migrated belongs (step S201). Although the P-VOL 103 is basically used as a volume to be selected, any volume may be used as long as it is a volume in the snapshot group 108 and the storage node 102.

For example, the reference snapshot update unit 612 may select the SS-VOL 104 to be migrated, may select the oldest SS-VOL 104, or may select the newest SS-VOL 104. When it is assumed that all the SS-VOLs 104 belonging to the first storage node 102A are to be migrated using the volume control information 605, the reference snapshot update unit 612 may newly create the SS-VOL 104 having mapping of the physical address 901 and the logical address 900 such that a difference data amount to be transferred is smallest.

Next, the reference snapshot update unit 612 creates a snapshot for the selected volume and sets the snapshot as the new RSS-VOL 105 in the first storage node 102A (step S202).

Next, the Difference Extraction Unit 107 Extracts difference data between the old RSS-VOL 105 and the new RSS-VOL 105 created in step S202 (step S203). The extraction processing of the difference data corresponds to the processing of extracting the difference area DIFF-BM 0200D and the area TFR-DATA 0201C that are required to be transferred in FIG. 4. When there are a plurality of old RSS-VOLs 105, the difference extraction unit 107 executes the above-described step S203 on each RSS-VOL 105, and adopts the RSS-VOL 105 having smallest difference data.

Next, the reference snapshot update unit 612 instructs the second storage node 102B to create a volume to be used as the RSS-VOL 105 from the first storage node 102A (step S204). The second storage node 102B that received the instruction creates a new volume and sets the new volume as the new RSS-VOL 105 in the second storage node 102B (step S205).

Finally, the reference snapshot update unit 612 reads and transmits all data of the RSS-VOL 105 created in step S202 from the first storage node 102A to the second storage node 102B (step S206). The second storage node 102B writes the received data to the RSS-VOL 105 created in step S205 described above (step S207). The reading and writing of data from and to the RSS-VOL 105 at this time is implemented by the snapshot migration unit 610 issuing, to the IO unit 606, an IO request to a volume in the same manner as the host 106 reads and writes data from and to the volume.

As described with reference to FIG. 4, the old RSS-VOL 105 may be deleted or may be left without being deleted. When the old RSS-VOL 105 is deleted, processing of deleting the old RSS-VOL 105 in the first storage node 102A and processing of instructing the second storage node 102B to delete the old RSS-VOL 105 may be added after step S207 described above. The determination of whether to delete the old RSS-VOL 105 may be uniformly fixed determination, or may be dynamically performed with reference to, for example, the volume control information 605, the capacity information 702, the load information 703, and the communication bandwidth information 704.

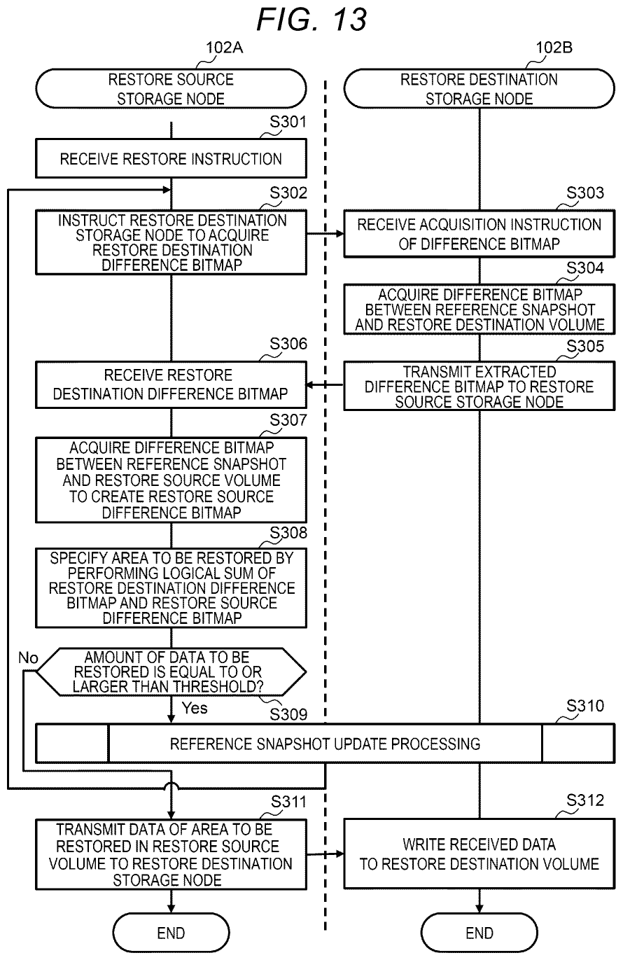

FIG. 13 is a flowchart showing an example of a procedure of the restore processing according to the first embodiment. The restore processing is executed by the restore unit 609 when a user designates a restore source and a restore destination for two volumes belonging to the same snapshot group 108 and instructs the storage apparatus 101 to restore data from the restore source to the restore destination. It should be noted that the shown example is processing contents to be executed when the volumes of the restore source and the restore destination are stored in different storage nodes 102, and when the volumes are stored in the same storage node 102, normal restore processing is executed, which is not a target of the shown processing. Therefore, in practice, prior to the processing shown in the example, it is determined whether the volume of the restore source and the volume of the restore destination designated by the user belong to the same storage node 102, whether to execute the normal restore processing or processing of switching to the processing shown in the example.

In general, a restore function restores the data of the P-VOL 103 using data of the SS-VOL 104 with the SS-VOL 104 serving as the restore source and the P-VOL 103 serving as the restore destination. However, in the present embodiment, a volume type does not matter as long as the volumes of both the restore source and the restore destination belong to the same snapshot group 108. For example, data of the SS-VOL 104 may be restored using data of the P-VOL 103 with the P-VOL 103 serving as the restore source and the SS-VOL 104 serving as the restore destination. This case generally has a function called resync, but in the present embodiment, since the processing contents do not change, they are not distinguished.

First, the first storage node 102A in which the volume of the restore source is present (hereinafter, also referred to as a “restore source storage node”) receives a restoration instruction (step S301). The restore instruction includes the volume ID 800 of the restore source and the volume ID 800 of the restore destination.

Next, the restore unit 609 of the first storage node 102A refers to the volume management information 604, specifies the second storage node 102B (hereinafter, also referred to as a “restore destination storage node”) to which the volume of the restore destination belongs, and then instructs the restore destination storage node 102B to acquire a restore destination volume, that is, a bitmap indicating a difference area between the SS-VOL 104 or the P-VOL 103 and the RSS-VOL 105 (step S302).

In response to the reception of the instruction (step S303), the restore destination storage node 102B calls the difference extraction unit 107 and acquires the restore destination volume, that is, the bitmap indicating a difference area between the SS-VOL 104 or the P-VOL 103 and the RSS-VOL 105 (step S304). The processing of acquiring the bitmap indicating the difference area corresponds to the processing of extracting the difference area DIFF-BM 0200B in FIG. 3. Thereafter, the difference extraction unit 107 transmits the difference data (the bitmap indicating the difference area) acquired by the restore destination storage node 102B to the restore source storage node 102A (step S305), and the restore source storage node 102A receives the difference data (step S306).

Next, the restore source storage node 102A calls the difference extraction unit 107 and acquires a bitmap indicating a difference area between the volume of the restore source (the SS-VOL 104 or the P-VOL 103) and the RSS-VOL 105 (step S307). The processing of acquiring the bitmap indicating the difference area corresponds to the processing of extracting the difference area DIFF-BM 0200C in FIG. 3.

Next, the storage node 102A calculates a logical sum of the difference data (the bitmap indicating the difference area) received from the restore destination storage node 102B in step S306 and the difference data (the bitmap indicating the difference area) acquired in step S307 to specify an area to be restored and data to be restored (step S308). The processing of specifying the area to be restored and the data to be restored corresponds to the processing of extracting the difference areas DIFF-BM-OR 0300 and TFR-DATA 0201B in FIG. 3.

When there are a plurality of RSS-VOLs 105, the difference extraction unit 107 executes step S302 to step S308 on each RSS-VOL 105, and adopts the RSS-VOL 105 having smallest restore target data.

Next, the difference extraction unit 107 determines whether the specified restore target data amount is equal to or larger than a predetermined threshold (step S309). When the specified restore target data amount is equal to or larger than the predetermined threshold, the difference extraction unit 107 proceeds the processing to step S310 and updates a reference snapshot. On the other hand, the difference extraction unit 107 executes step S11 when the specified restore target data amount is less than the predetermined threshold. This processing corresponds to the processing for reducing the overhead of transfer between the plurality of storage nodes 102A and 102B to fall within a predetermined range described in FIG. 3. Basically, the threshold is set by a ratio to the volume capacity 801, but the threshold may be set by a different method. The threshold may be dynamically adjusted, and for example, may be adjusted with reference to the capacity information 702, the load information 703, and the communication bandwidth information 704.

In step S310, the reference snapshot update unit 612 is called, and the reference snapshot update unit 612 updates the RSS-VOL 105 so as to reduce the transfer overhead. Details of the processing were described with reference to FIG. 12 described above, and description thereof will be omitted. When the update of the RSS-VOL 105 is completed, step S302 is executed. In step S302, the reference snapshot update unit 612 specifies restore data again using the updated RSS-VOL 105.

In step S311, the reference snapshot update unit 612 reads the restore target data specified in step S308 from the volume of the restore source, that is, the SS-VOL 104 or the P-VOL 103, and transmits the restore target data from the restore source storage node 102A to the restore destination storage node 102B. The restore destination storage node 102B writes the received data to the volume of the restore destination (step S312). At this time, reading and writing of data from and to the volumes of the restore source and the restore destination are implemented by the restore unit 609 issuing, to the IO unit 606, an IO request to a volume in the same manner as the host 106 reading and writing data from and to the volume.

As described above, in the present embodiment, the common RSS-VOL 105 is provided in each of the storage nodes 102A and 102B, and by using the RSS-VOL 105 as a reference, difference management across the plurality of storage nodes 102A and 102B can be achieved, and by using the difference management, the first storage node 102A transfers only the difference data, so that the migration processing of the SS-VOL 104 and the restore processing can be achieved.

In the present embodiment as described above, the snapshot migration processing and the restore processing can be efficiently executed by transferring only the difference data, but in order to provide the common reference snapshot in each of the storage nodes 102, data for approximately one volume is transferred among the storage nodes in advance, and a reference snapshot is copied. Here, when the snapshot migration processing and the restore processing are frequently executed, the effect of reducing a transfer data amount by providing the reference snapshot described above is increased.

When the storage system 100 includes a plurality of the storage apparatuses 101, some of the storage apparatuses 101 have an external volume connection function of connecting an own storage apparatus to a volume provided by another storage apparatus 101 as if the host 106 is the host 106 in the own storage apparatus, and enabling the connected volume to be handled as if the volume is a volume provided by the own storage apparatus. It is possible to reduce a data transfer amount related to copying a reference snapshot by connecting the reference snapshot volume among the storage nodes 102 by using the external volume connection function, instead of copying the RSS-VOL 105 among the storage nodes 102.

The storage system 100 according to the present embodiment described above is a storage apparatus including the first storage node 102A having the P-VOL 103 which is an example of a primary volume from or to which data is read or written with the host 106, and the second storage node 102B. The first storage node 102A and the second storage node 102B respectively store the RSS-VOL 105A1 and the RSS-VOL 105A2 which are examples of the same reference snapshot volume. That is, the first storage node 102A stores the RSS-VOL 105A1, and the second storage node 102B stores the RSS-VOL 105A2 similar to the RSS-VOL 105A1. The first storage node 102A and the second storage node 102B manage snapshots using difference data between the RSS-VOL 105A1 and the RSS-VOL 105A2 which are examples of the reference snapshot volume and the SS-VOLs 104A to 104C which are examples of a snapshot volume.

When the SS-VOL 104A to 104C serving as examples of a snapshot volume of the P-VOL 103 which is an example of a primary volume are to be migrated to the second storage node 102B, for the snapshot volumes SS-VOL 104A to 104C to be migrated, the first storage node 102A extracts difference data between the RSS-VOL 105A1 serving as an example of a first reference snapshot volume which is a reference snapshot volume of the first storage node 102A and each of the SS-VOLs 104A to 104C which are examples of a snapshot volume to be migrated, and transfers the difference data to the second storage node 102B. The second storage node 102B uses the transferred difference data and the RSS-VOL 105A2 (second reference snapshot volume) which is a reference snapshot volume of the second storage node 102B to reproduce the snapshot volume to be migrated in the RSS-VOL 104B2 which is an example of a second snapshot volume.

According to the present embodiment described above, the acquired snapshot volume can be migrated to the second storage node 102B while reducing a data transfer amount among the plurality of storage nodes 102A and 102B, for example, without copying and repeatedly transferring all the acquired snapshot volumes. Further, it is possible to prevent imbalance in a storage capacity and a load among the plurality of storage nodes 102A and 102B.

Further, by managing the difference area (difference data) in data between the P-VOL 103 and the SS-VOLs 104A to 104C across the plurality of storage nodes 102A and 102B, for example, in the restore processing in a case where the P-VOL and the SS-VOL are present in different storage nodes 102, it is not necessary to transfer all data of a volume among the plurality of storage nodes 102, a processing time can be shortened, and an influence on the network 500 among the plurality of storage nodes 102 can be reduced. According to the present embodiment, it is possible to prevent the entire area of a restore destination from becoming a difference area by overwriting the entire area of a volume of the restore destination, and it is possible to prevent the consumption of a storage capacity from increasing.

In the present embodiment, the first storage node 102A repeatedly creates a snapshot volume and holds the plurality of snapshot volumes 104A to 104C for each generation, and when a deviation between the RSS-VOL 105A1 and a relatively new snapshot volume, preferably the latest snapshot volume 104C among the plurality of snapshot volumes 104A to 104C, becomes larger than a predetermined threshold, the first storage node 102A and the second storage node 102B update the respective reference snapshot volumes and hold the same updated reference snapshot volume. In this manner, even if the plurality of snapshot volumes 104A to 104C for each generation are held, a timing of re-creating the RSS-VOL 105A1 becomes clear, and the RSS-VOL 105A1 can be updated at an appropriate timing.

In the present embodiment, when a reference snapshot volume is updated, the first storage node 102A updates the RSS-VOL 105A1 which is an example of the first reference snapshot volume and transmits updated difference data with the RSS-VOL 105A1 to the second storage node 102B, and the second storage node 102B updates the second reference snapshot volume RSS-VOL 105A2 using the updated difference data with the RSS-VOL 105A1.

In the present embodiment, the second storage node 102B acquires a reference snapshot in the RSS-VOL 105A1 by connecting the RSS-VOL 105A2 which is an example of the second reference snapshot volume to the RSS-VOL 105A1 which is an example of the first reference snapshot volume of the first storage node 102A by the external volume connection function. In this manner, for example, all of the acquired snapshot volumes can be migrated to a migration destination storage node while reducing a data transfer amount among the plurality of storage nodes, for example, without copying and repeatedly transferring all the acquired snapshot volumes.

In the present embodiment, the first storage node 102A creates a first bitmap indicating the presence or absence of a difference between a storage area of the RSS-VOL 105A1 serving as an example of the first reference snapshot volume which is a reference snapshot volume of the first storage node 102A, and a storage area of the SS-VOL 104B1 which is an example of a first snapshot volume stored in the first storage node 102A. The second storage node 102B creates a second bitmap indicating the presence or absence of a difference between a storage area of the RSS-VOL 105A2 serving as an example of a second reference snapshot volume which is a reference snapshot volume of the second storage node 102B, and a storage area of the SS-VOL 104B2 which is an example of the second snapshot volume stored in the second storage node. When the second snapshot volume stored in the second storage node 102B is to be restored to the first storage node 102A, the second storage node 102B determines and transfers data to be transferred to the first storage node 102A among data of the second snapshot volume SS-VOL 104B2 based on the first bitmap and the second bitmap. The first storage node 102A restores the SS-VOL 104B2 which is an example of the second snapshot volume by using the transferred data of the SS-VOL 104B2 which is an example of the second snapshot volume, the RSS-VOL 105A1 which is an example of the first reference snapshot volume, and the SS-VOL 104B1 which is an example of the first snapshot volume.

In the present embodiment, the first storage node 102A creates a first bitmap indicating the presence or absence of a difference between a storage area of the RSS-VOL 105A1 serving as the first reference snapshot volume which is a reference snapshot volume of the first storage node 102A, and a storage area of the SS-VOL 104B1 which is a first snapshot volume stored in the first storage node 102A. The second storage node 102B creates a second bitmap indicating the presence or absence of a difference between a storage area of the RSS-VOL 105A2 serving as a second reference snapshot volume which is a reference snapshot volume of the second storage node 102B, and the SS-VOL 104B2 which is a second snapshot volume stored in the second storage node 102B. In the present embodiment, when the first snapshot volume SS-VOL 104B1 stored in the first storage node 102A is to be created in the second storage node 102B, the first storage node 102A determines and transfers data to be transferred to the second storage node 102B among data of the first snapshot volume SS-VOL 104B1 based on the second bitmap and the first bitmap. The second storage node 102B creates the first snapshot volume SS-VOL 104B1 by using the transferred data of the first snapshot volume SS-VOL 104B1, the second reference snapshot volume RSS-VOL 105A2, and the second snapshot volume SS-VOL 104B2.

### (2) Second Embodiment

Since a storage system including a storage apparatus according to the second embodiment has substantially the same configuration and operation as the storage system including the storage apparatus according to the first embodiment, in the second embodiment, description of the same configuration and operation as those of the first embodiment will be omitted, and different points will be mainly described below.

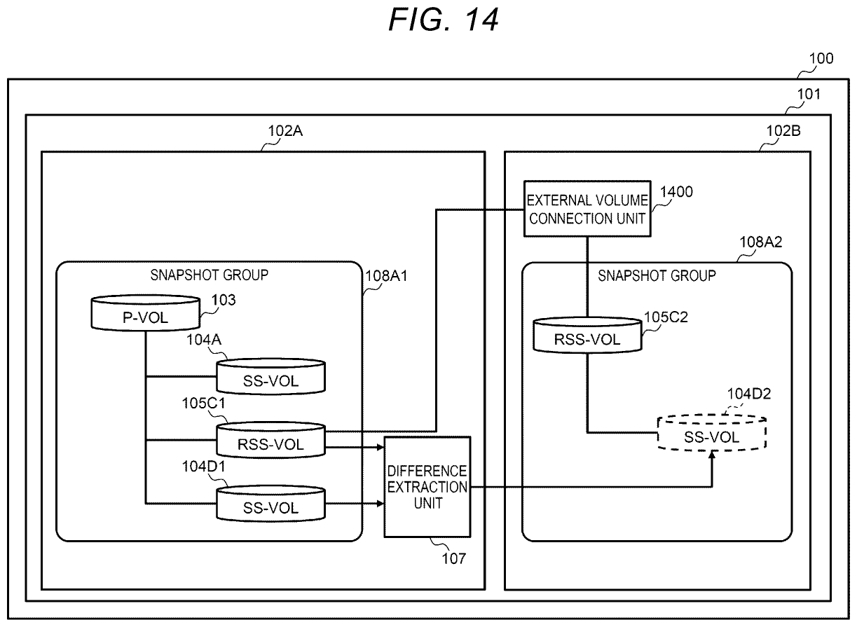

The storage apparatus according to the second embodiment is implemented using the above-described external storage connection function. Hereinafter, the second embodiment of the invention will be described with reference to FIGS. 14 to 18. In the second embodiment, a part of the first embodiment is replaced with a configuration and processing using the external storage connection function.

That is, the second storage node 102B acquires a reference snapshot in the RSS-VOL 105A1 by connecting the RSS-VOL 105A2 which is an example of the second reference snapshot volume with the RSS-VOL 105A1 which is an example of the first reference snapshot volume in the first storage node 102A by the external volume connection function. Hereinafter, details will be described.

FIG. 14 is a diagram showing a configuration example and an operation example of the storage system 100 including the storage apparatus according to the second embodiment. In the shown example, the host 106 is omitted for simplification of description. The host 106 can be connected to the P-VOL 103 and each SS-VOL 104 to request reading and writing of data.

The example shows an operation of migrating an SS-VOL 104D1 from the first storage node 102A to an SS-VOL 104D2 of the second storage node 102B using RSS-VOLs 105C1 and 105C2. The RSS-VOL 105C1 present in the storage node 102A is a reference snapshot created as a snapshot of the P-VOL 103 and is similar to, for example, the RSS-VOL 105A1 shown in FIG. 1 in the first embodiment. The RSS-VOL 105C2 present in the storage node 102B is connected from the storage node 102B to the RSS-VOL 105C1 of the storage node 102A using an external volume connection unit 1400 operating in the second storage node 102B. The RSS-VOL 105C2 can be basically handled in the same manner as a normal volume, but data read from and written to the RSS-VOL 105C2 is transferred to the RSS-VOL 105C1 via the external volume connection unit 1400 (and the communication port 504).

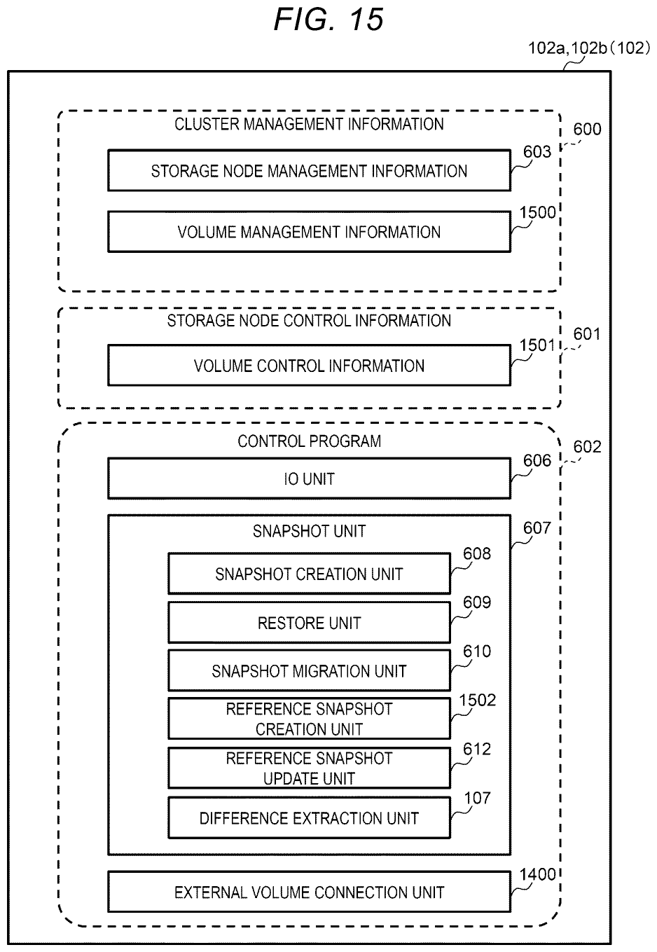

FIG. 15 is a diagram showing a logical configuration example of the storage node 102 (102A, 102B) in the second embodiment. The configuration example shown in FIG. 15 is different from the corresponding configuration example shown in FIG. 6 in the first embodiment in that the control program 602 includes the external volume connection unit 1400.

The external volume connection unit 1400 exhibits the above-described external volume connection function, connects to a volume provided by another storage apparatus 101, and has a function that makes it possible to handle a volume as if the volume is a volume provided by an own storage apparatus. In the present embodiment, this function is used for the purpose of sharing the RSS-VOL 105 between the storage nodes 102.

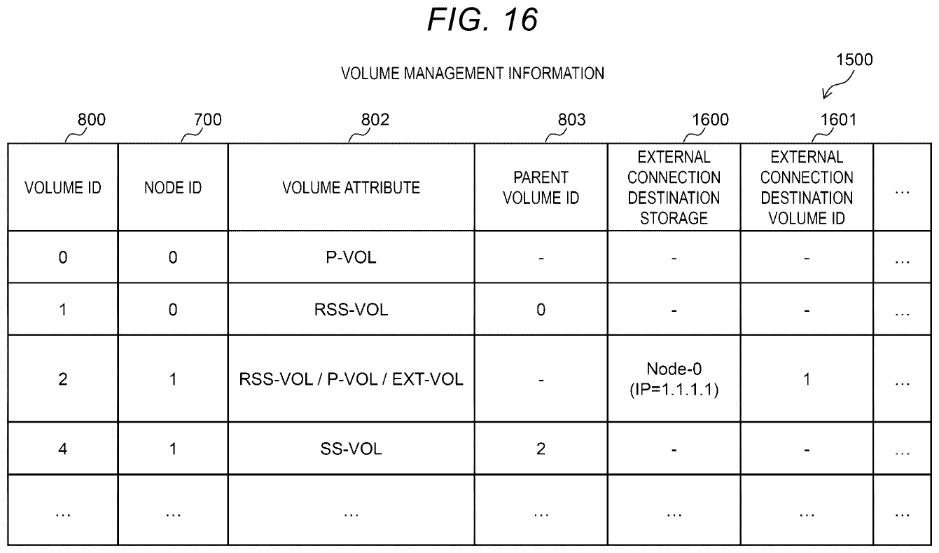

FIG. 16 is a diagram showing an example of volume management information 1500 in the second embodiment. The volume management information 1500 is different from the volume management information 604 shown in FIG. 8 in the first embodiment in that the volume management information 1500 includes an external connection destination storage 1600 and an external connection destination volume ID 1601. Further, the volume attribute 802 is newly added with information “EXT-VOL” indicating a volume using the external volume connection unit 1400. Although some columns, for example, the volume capacity 801 is omitted in the shown example, the volume capacity 801 is included in practice.

The external connection destination storage 1600 and the external connection destination volume ID 1601 are information for respectively managing the storage apparatus 101 and a volume connected by the external volume connection unit 1400. In the shown example, a volume with the volume ID 800 of “2” is a volume using the external volume connection unit 1400, that is, has “EXT-VOL” as the volume attribute 802. “Node-0 (IP=1.1.1.1)” (own storage apparatus, another storage node of own storage apparatus) indicates that an external connection destination is a volume with the volume ID 800 of “0”.

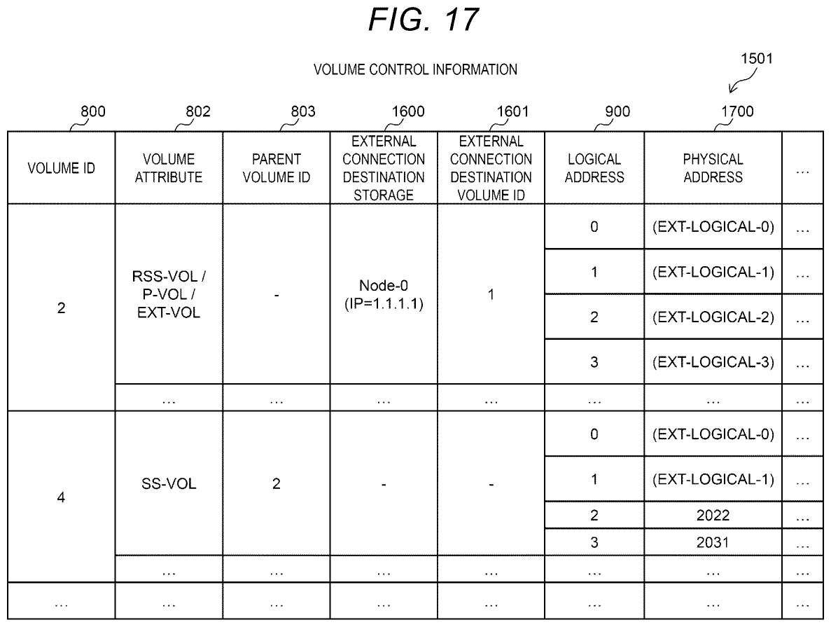

FIG. 17 is a diagram showing volume control information 1501 in the second embodiment. Although some columns, for example, the volume capacity 801 described above is omitted in the shown example, the volume capacity 801 is included in practice.

In the shown example, there is a block “(EXT-LOGICAL-<number>)” as a physical address 1700 associated with the logical address 900. This indicates that data of the logical address is present in a volume of another storage apparatus indicated by the external connection destination storage 1600 and the external connection destination volume ID 1601. The numeral portion indicates that data corresponding to the logical address 900 is present at the logical address 900 of a volume indicated by the external connection destination volume ID 1601. When the IO unit 606 receives an IO request for a block in which the physical address 1700 corresponding to the logical address 900 is an external connection destination storage, the IO unit 606 relays the IO request to a volume indicated by the external connection destination volume ID 1601 of the external connection destination storage 1600 via the external storage connection unit 1400.

In the shown example, “Node-0 (IP =1.1.1.1)” (own storage apparatus, another storage node of own storage apparatus) indicates that a data block having the logical address 900 of “0” of a volume with the volume ID 800 of “2” is associated with an area having the logical address 900 of “0” of a volume with the volume ID 800 of “0”.

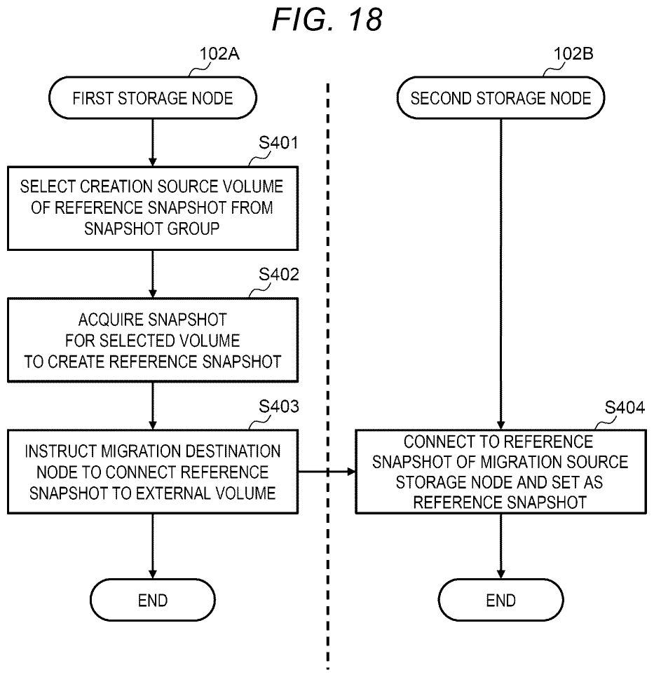

FIG. 18 is a flowchart showing an example of a procedure of reference snapshot creation processing in the second embodiment. This procedure may be executed when the reference snapshot is created for the first time, may be executed when the reference snapshot is updated, or may be executed at any timing. The reference snapshot creation processing is executed by calling a reference snapshot creation unit 1502 from the snapshot migration unit 610.

First, in step S401, the reference snapshot creation unit 1502 selects a volume that is a source of a reference snapshot volume from the snapshot group 108 and the storage node 102, to which the SS-VOL 104 to be migrated belongs. Step S401 is the same as step S101 shown in FIG. 11 in the first embodiment.

Next, the reference snapshot creation unit 1502 creates a snapshot for the selected volume and sets the snapshot as the RSS-VOL 105 in the first storage node 102A (step S402). Step S402 is the same as step S102 shown in FIG. 11 in the first embodiment.

Next, the external volume connection unit 1400 instructs the second storage node 102B to connect the RSS-VOL 105 created in step S402 from the first storage node 102A to the second storage node 102B (step S403). This connection instruction includes information for connecting to the RSS-VOL 105 from the second storage node 102B, such as the volume ID 800 of the reference snapshot volume created in step S402 described above.

In the second storage node 102B that received the connection instruction, the external volume connection unit 1400 connects to the reference snapshot volume of the first storage node 102A according to the connection instruction, and sets the reference snapshot volume as the RSS-VOL 105 in the second storage node 102B (step S404). Thereafter, both the first storage node 102A and the second storage node 102B execute snapshot migration by using the RSS-VOL 105 that can be used by external connection setting at this time.

The invention is not limited to the embodiments described above, and includes various modifications and equivalent configurations within the scope of the appended claims. For example, the embodiments described above have been described in detail to facilitate understanding of the invention, and the invention is not limited to those including all the above-described configurations. At least one of the elements described as being connected in parallel in the embodiments may be connected in series to another element.

### INDUSTRIAL APPLICABILITY

The invention can be applied to a storage apparatus related to a technique for creating a snapshot volume using a snapshot function.

What is claimed is:

1. A storage apparatus comprising:
a first storage node having a primary volume from or to which data is read or written with a host; and
a second storage node, wherein
each of the first storage node and the second storage node holds a snapshot volume and a same reference snapshot volume, and
the first storage node and the second storage node manage the snapshot volume based on difference data between the reference snapshot volume and the snapshot volume.

2. The storage apparatus according to claim 1, wherein
when migrating a snapshot volume of the primary volume to the second storage node,
the first storage node extracts, for the snapshot volume to be migrated, difference data between a first reference snapshot volume that is a reference snapshot volume of the first storage node and the snapshot volume to be migrated, and transfers the difference data to the second storage node, and
the second storage node reproduces the snapshot volume to be migrated in a second snapshot volume using the transferred difference data and a second reference snapshot volume that is a reference snapshot volume of the second storage node.

3. The storage apparatus according to claim 2, wherein
the first storage node repeatedly creates the snapshot volume and holds a plurality of first snapshot volumes for each generation, and
when a deviation between the created first snapshot volume and the first reference snapshot volume is larger than a predetermined threshold, the first storage node and the second storage node update the reference snapshot volume in each of the first storage node and the second storage node and hold the same updated reference snapshot volume.

4. The storage apparatus according to claim 3, wherein
when updating the reference snapshot volume,
the first storage node updates the first reference snapshot volume and transmits updated difference data with the first reference snapshot volume to the second storage node, and
the second storage node updates the second reference snapshot volume using the updated difference data with the first reference snapshot volume.

5. The storage apparatus according to claim 1, wherein
the second storage node acquires a reference snapshot in a first reference snapshot volume by connecting a second reference snapshot volume to the first reference snapshot volume of the first storage node by an external volume connection function.

6. The storage apparatus according to claim 1, wherein
the first storage node creates a first bitmap indicating presence or absence of a difference between a storage area of a first reference snapshot volume which is a reference snapshot volume of the first storage node and a storage area of a first snapshot volume stored in the first storage node,
the second storage node creates a second bitmap indicating presence or absence of a difference between a storage area of a second reference snapshot volume which is a reference snapshot volume of the second storage node and a storage area of a second snapshot volume stored in the second storage node, and
when restoring the second snapshot volume stored in the second storage node to the first storage node,
the second storage node determines data to be transferred to the first storage node among data of the second snapshot volume based on the first bitmap and the second bitmap, and transfers the data, and
the first storage node restores the second snapshot volume using the transferred data of the second snapshot volume, the first reference snapshot volume, and the first snapshot volume.

7. The storage apparatus according to claim 1, wherein
the first storage node creates a first bitmap indicating presence or absence of a difference between a storage area of a first reference snapshot volume which is a reference snapshot volume of the first storage node and a storage area of a first snapshot volume stored in the first storage node,
the second storage node creates a second bitmap indicating presence or absence of a difference between a storage area of a second reference snapshot volume which is a reference snapshot volume of the second storage node and a storage area of a second snapshot volume stored in the second storage node, and
when creating the first snapshot volume stored in the first storage node in the second storage node,
the first storage node determines data to be transferred to the second storage node among data of the first snapshot volume based on the second bitmap and the first bitmap, and transfers the data, and
the second storage node creates the first snapshot volume using the transferred data of the first snapshot volume, the second reference snapshot volume, and the second snapshot volume.

8. A storage control method for a storage system including a first storage node having a primary volume from or to which data is read or written with a host, and a second storage node, the storage control method comprising:
a holding step of holding a snapshot volume and a same reference snapshot volume in each of the first storage node and the second storage node; and
a management step of managing the snapshot volume based on difference data between the reference snapshot volume and the snapshot volume by the first storage node and the second storage node.

9. The storage control method according to claim 8, further comprising:
a transfer step of, when migrating a snapshot volume of the primary volume to the second storage node, extracting, for the snapshot volume to be migrated, difference data between a first reference snapshot volume that is a reference snapshot volume of the first storage node and the snapshot volume to be migrated, and transferring the difference data to the second storage node by the first storage node; and
a reproducing step of reproducing the snapshot volume to be migrated in a second snapshot volume by the second storage node using the transferred difference data and a second reference snapshot volume that is a reference snapshot volume of the second storage node.

10. The storage control method according to claim 8, wherein
the first storage node repeatedly creates the snapshot volume and holds a plurality of first snapshot volumes for each generation, and
when a deviation between the created first snapshot volume and the first reference snapshot volume is larger than a predetermined threshold, the first storage node and the second storage node update the reference snapshot volume in each of the first storage node and the second storage node and hold the same updated reference snapshot volume.

11. The storage control method according to claim 8, wherein
when updating the reference snapshot volume,
the first storage node updates a first reference snapshot volume and transmits updated difference data with the first reference snapshot volume to the second storage node, and
the second storage node updates a second reference snapshot volume using the updated difference data with the first reference snapshot volume.

12. The storage control method according to claim 8, wherein
the second storage node acquires a reference snapshot in a first reference snapshot volume by connecting a second reference snapshot volume to the first reference snapshot volume of the first storage node by an external volume connection function.

13. The storage control method according to claim 8, wherein
the first storage node creates a first bitmap indicating presence or absence of a difference between a storage area of a first reference snapshot volume which is a reference snapshot volume of the first storage node and a storage area of a first snapshot volume stored in the first storage node,
the second storage node creates a second bitmap indicating presence or absence of a difference between a storage area of a second reference snapshot volume which is a reference snapshot volume of the second storage node and a storage area of a second snapshot volume stored in the second storage node, and
when restoring the second snapshot volume stored in the second storage node to the first storage node,
the second storage node determines data to be transferred to the first storage node among data of the second snapshot volume based on the first bitmap and the second bitmap, and transfers the data, and
the first storage node restores the second snapshot volume using the transferred data of the second snapshot volume, the first reference snapshot volume, and the first snapshot volume.
